(19) United States
(12) Patent Application Publication
(10) Pub. No.: US 2002/0129123 A1
(43) Pub. Date: Sep. 12, 2002

(54) Systems and methods for intelligent information retrieval and delivery in an information management environment

(76) Inventors: Scott C. Johnson, Round Rock, TX (US); Chaoxin C. Qiu, Austin, TX (US); Roger K. Richter, Leander, TX (US)

Correspondence Address: O'KEEFE, EGAN & PETERMAN, L.L.P., Building C, Suite 200, 1101 Capital of Texas Highway South, Austin, TX, 78746, US

(21) Appl. No.: 10/003,728

(22) Filed: Nov. 2, 2001

Related U.S. Application Data
(60) Provisional application No. 60/285,211, filed on Apr. 20, 2001.
(60) Provisional application No. 60/291,073, filed on May 15, 2001.
(60) Provisional application No. 60/246,445, filed on Nov. 7, 2000.
(60) Provisional application No. 60/246,359, filed on Nov. 7, 2000.
(60) Provisional application No. 60/187,211, filed on Mar. 3, 2000.
(60) Provisional application No. 60/246,401, filed on Nov. 7, 2000.

(51) Int. Cl. G06F 15/16

(52) U.S. Cl. 709/219; 709/203; 709/232

(57) ABSTRACT

Methods and systems for intelligent information retrieval and delivery in information delivery environments that may be employed in a variety of information management system environments, including those employing high-end streaming servers. The disclosed methods and systems may be implemented to achieve a variety of information delivery goals, including delivery of continuous content in a manner that is free or substantially free of interruptions and hiccups, to enhance the efficient use of information retrieval resources such as buffer/cache memory, and/or to allocate information retrieval resources among simultaneous users, such as during periods of system congestion or overuse.

This application claims priority from co-pending U.S. patent application Ser. No. 09/947,869, filed on Sep. 6, 2001, which is entitled SYSTEMS AND METHODS FOR RESOURCE MANAGEMENT IN INFORMATION STORAGE ENVIRONMENTS, the disclosure of which is incorporated herein by reference. This application also claims priority from co-pending U.S. patent application Ser. No. 09/879,810 filed on Jun. 12, 2001 which is entitled “SYSTEMS AND METHODS FOR PROVIDING DIFFERENTIATED SERVICE IN INFORMATION MANAGEMENT ENVIRONMENTS,” and also claims priority from co-pending Provisional Application Serial No. 60/285,211 filed on Apr. 20, 2001 which is entitled “SYSTEMS AND METHODS FOR PROVIDING DIFFERENTIATED SERVICE IN A NETWORK ENVIRONMENT,” and also claims priority from co-pending Provisional Application Serial No. 60/291,073 filed on May 15, 2001 which is entitled “SYSTEMS AND METHODS FOR PROVIDING DIFFERENTIATED SERVICE IN A NETWORK ENVIRONMENT,” the disclosures of each of the forgoing applications being incorporated herein by reference. This application also claims priority from co-pending U.S. patent application Ser. No. 09/797,198 filed on Mar. 1, 2001 which is entitled “SYSTEMS AND METHODS FOR MANAGEMENT OF MEMORY,” and also claims priority from co-pending U.S. patent application Ser. No. 09/797,201 filed on Mar. 1, 2001 which is entitled “SYSTEMS AND METHODS FOR MANAGEMENT OF MEMORY IN INFORMATION DELIVERY ENVIRONMENTS,” and also claims priority from co-pending Provisional Application Serial No. 60/246,445 filed on Nov. 7, 2000 which is entitled “SYSTEMS AND METHODS FOR PROVIDING EFFICIENT USE OF MEMORY FOR NETWORK SYSTEMS,” and also claims priority from co-pending Provisional Application Serial No. 60/246,359 filed on Nov. 7, 2000 which is entitled “CACHING ALGORITHM FOR MULTIMEDIA SERVERS,” the disclosures of each of the forgoing applications being incorporated herein by reference. This application also claims priority from co-pending U.S. patent application Ser. No. 09/97,200 filed on Mar. 1, 2001 which is entitled “SYSTEMS AND METHODS FOR THE DETERMINISTIC MANAGEMENT OF INFORMATION” which itself claims priority from Provisional Application Serial No. 60/187,211 filed on Mar. 3, 2000 which is entitled “SYSTEM AND APPARATUS FOR INCREASING FILE SERVER BANDWIDTH,” the disclosures of each of the forgoing applications being incorporated herein by reference. This application also claims priority from co-pending Provisional Application Serial No. 60/246,401 filed on Nov. 7, 2000 which is entitled “SYSTEM AND METHOD FOR THE DETERMINISTIC DELIVERY OF DATA AND SERVICES,” the disclosure of which is incorporated herein by reference.

### BACKGROUND OF THE INVENTION

The present invention relates generally to information management, and more particularly, to intelligent information retrieval and delivery in information delivery environments.

Storage for network servers may be internal or external, depending on whether storage media resides within the same chassis as the information management system itself. For example, external storage may be deployed in a cabinet that contains a plurality of disk drives. A server may communicate with internal or external disk drives, for example, by way of SCSI, Fibre Channel, or other protocols (e.g., Infiniband, iSCSI, etc.).

Due to the large number of files typically stored on such devices, access to any particular file may be a relatively time consuming process. However, distribution of file requests often favors a small subset of the total files referenced by the system. In an attempt to improve speed and efficiency of responses to file requests, cache memory schemes, typically algorithms, have been developed to store some portion of the more heavily requested files in a memory form that is quickly accessible to a computer microprocessor, for example, random access memory (“RAM”). When cache memory is so provided, a microprocessor may access cache memory first to locate a requested file, before taking the processing time to retrieve the file from larger capacity external storage.

Caching algorithms attempt to keep disk blocks within cache memory that have already been read from disk, so that these blocks will be available in the event that they are requested again. In addition, buffer/cache schemes may implement a read-ahead algorithm, working on the assumption that blocks subsequent to a previously requested block may also be requested. Buffer/cache algorithms may reside in the operating system (“OS”) of the server itself, and be run on the server processor(s) themselves. Adapter cards have been developed that perform a level of caching below the OS. These adapter cards may contain large amounts of RAM, and may be configured for connection to external disk drive arrays (e.g. through FC, SCSI, etc.). Buffer/cache algorithms may also reside within a storage processor (“SP”) or external controller that is present within an external disk drive array cabinet. In such a case, the server has an adapter that may or may not have cache, and that communicates with the external disk drive array through the SP/controller. Buffer/cache schemes implemented on a SP/controller function in the same way as on the adapter.

In an effort to further improve performance and reliability of disk drive arrays, a disk configuration known as Redundant Array of Independent Disks (“RAID”) has been developed. RAID systems include a plurality of disks (together referred to as a “RAID array”) that are controlled in a manner that implements the RAID functionality. In this regard, a number of RAID functionality levels have been defined, each providing a means by which the array of disk drives is manipulated as a single entity to provide increased performance and/or reliability. RAID algorithms may reside on the server processor, may be offloaded to a processor running on a storage adapter, or may reside on the SP/controller present in an external drive array chassis. RAID controllers are typically configured with some caching ability.

Despite the implementation of buffer/cache schemes and disk configurations such as RAID, inefficiencies and/or disruptions may be encountered in data delivery, such as delivery of streaming content. For example, in the implementation of conventional read-ahead schemes, a SP may consume its available memory in the performance of read-ahead operations to service content requests for a portion of existing viewers. When this occurs, one or more other existing viewers may experience a “hiccup” or disruption in data delivery due to lack of available SP memory to service their respective content requests.

### SUMMARY OF THE INVENTION

Disclosed herein are methods and systems for information retrieval and delivery in information delivery environments that may be employed to optimize buffer/cache performance by intelligently managing or controlling information retrieval rates. The disclosed methods and systems may be advantageously implemented in the delivery of a variety of data object types including, but not limited to, over-size data objects such as continuous streaming media data files and very large non-continuous data files, and may be employed in such environments as streaming multimedia servers or web proxy caching for streaming multimedia files. The disclosed methods and systems may be implemented in a variety of information management system environments, including those employing high-end streaming servers.

The disclosed methods and systems for intelligent information retrieval may be implemented to achieve a variety of information delivery goals, including to ensure that requested memory units (e.g., data blocks) are resident within a buffer/cache memory when the data blocks are required to be delivered to a user of a network in a manner that prevents interruption or hiccups in the delivery of the over-size data object, for example, so that the memory units are in buffer/cache memory whenever requested by an information delivery system, such as a network or web server. Advantageously, this capability may be implemented to substantially eliminate the effects of latency due to disk drive head movement and data transfer rate. Intelligent information retrieval may also be practiced to enhance the efficient use of information retrieval resources such as buffer/cache memory, and/or to allocate information retrieval resources among simultaneous users, such as during periods of system congestion or overuse. This intelligent retrieval of information may be advantageously implemented as part of a read-ahead buffer scheme, or as a part of information retrieval tasks associated with any other buffer/cache memory management method or task including, but not limited to, caching replacement, I/O scheduling, QoS resource scheduling, etc.

In one respect, the disclosed methods and systems may be employed in a network connected information delivery system that delivers requested information at a rate that is dependent or based at least in part on the information delivery rate sustainable by the end user, and/or the intervening network. This information delivery rate may be monitored or measured in real time, and then used to determine an information retrieval rate, for example, using the same processor that monitors information delivery rate or by communicating the monitored information delivery rate to a processing engine responsible for controlling buffer/cache duties, e.g., server processor, separate storage management processing engine, logical volume manager, system admission control processing engine, etc. Given the monitored information delivery rate, the processing engine responsible for controlling buffer/cache duties may then retrieve the requested information for buffer/cache memory from one or more storage devices at a rate determined to ensure that the desired information (e.g., the next requested memory unit such as data block) is always present in buffer/cache memory when needed to satisfy a request for the information, thus minimizing interruptions and hiccups.

In another respect, the disclosed methods and systems may be implemented in a network connected information delivery system to set an information retrieval rate for one or more given individual users of the system to be equal, substantially equal, or that is proportional to, the corresponding information delivery rate for the respective users of the system a manner that increases the efficient use of information retrieval resources (e.g., buffer cache memory use). This is made possible because information retrieval resources consumed for each user may be tailored to the actual monitored delivery rate to that user, with no extra retrieval resources wasted to achieve information retrieval rates greater than the maximum information delivery rate possible for a given user.

In another respect, the disclosed methods and systems may be implemented in a network connected information delivery system to retrieve information for a plurality of users in a manner that is differentiated between individual users and/or groups of users. Such differentiated retrieval of information may be implemented, for example, to prioritize the retrieval of information for one or more users relative to one or more other users. For example, information retrieval rates may be determined for one or more users that is sufficient to ensure or guarantee that the desired information is always present in buffer/cache memory when needed to satisfy relatively higher priority requests for the information, while information retrieval rates for one or more other users may be determined in a manner that allows information retrieval rates for these other users to drop below a value that is sufficient to ensure or guarantee that the desired information is always present in buffer/cache memory when needed to satisfy relatively lower priority requests for information. By allowing information retrieval rates to degrade for relatively lower priority requests, sufficient information retrieval resources may be reserved or retained to ensure uninterrupted or hiccup-free delivery of information to satisfy relatively higher priority requests.

In another respect, disclosed is a method of retrieving information for delivery across a network to at least one user, including the steps of monitoring an information delivery rate across the network to the user; determining an information retrieval rate based at least in part on the monitored information delivery rate; retrieving information from at least one storage device coupled to the network at the determined information retrieval rate; and delivering the retrieved information across the network to the user. The method may further include adjusting the determined information retrieval rate on a real time basis by monitoring the information delivery rate across the network to the user on a real time basis; and determining the information retrieval rate on a real time basis based at least in part on the real time monitored information delivery rate.

In another respect, disclosed is a method of retrieving information from a storage system having at least one storage management processing engine coupled to at least one storage device and delivering the information across a network to a user from a server coupled to the storage system. The method may include the steps of: monitoring an information delivery rate across the network from the server to the user; determining an information retrieval rate based at least in part on the monitored information delivery rate; using the storage management processing engine to retrieve information from the at least one storage device at the determined information retrieval rate and to store the retrieved information in a buffer/cache memory of the storage management processing engine; and delivering the stored information from the buffer/cache memory across the network to the user via the server. The method may further include adjusting the determined information retrieval rate on a real time basis by monitoring the information delivery rate across the network from the server to the user on a real time basis; and determining the information retrieval rate on a real time basis based at least in part on the real time monitored information delivery rate.

In another respect, disclosed is a network-connectable storage system, including at least one storage device, and a storage management processing engine coupled to the at least one storage device, the storage management processing engine including a buffer/cache memory. The storage management processing engine may be capable of determining an information retrieval rate for retrieving information from the storage device and storing the information in the buffer/cache memory, the information retrieval rate being determined based at least in part on a monitored information delivery rate from a server to a user across the network that is communicated to the storage management processing engine from a server coupled to the storage management processing engine. The storage management processing engine may be further capable of adjusting the determined information retrieval rate on a real time basis by monitoring the information delivery rate across the network from the server to the user on a real time basis; and determining the information retrieval rate on a real time basis based at least in part on the real time monitored information delivery rate.

In another respect, disclosed is a method of retrieving information from at least one storage device and delivering the information across a network to a user from a server coupled to the storage device. The method may include the steps of: monitoring an information delivery rate across the network from the server to the user; determining an information retrieval rate based at least in part on the monitored information delivery rate; retrieving the information from the at least one storage device at the determined information retrieval rate and storing the retrieved information in a buffer/cache memory coupled to the server; and delivering the stored information from the buffer/cache memory across the network to the user via the server. The method may further include adjusting the determined information retrieval rate on a real time basis by monitoring the information delivery rate across the network from the server to the user on a real time basis; and determining the information retrieval rate on a real time basis based at least in part on the real time monitored information delivery rate.

In another respect, disclosed is a network-connectable server system, the system including a server including at least one server processor; and a buffer/cache memory coupled to the server. The server may be further connectable to at least one storage device; and the at least one server processor may be capable of monitoring an information delivery rate across a network from the server to a user, and may be further capable of determining an information retrieval rate for retrieving information from the storage device and storing the information in the buffer/cache memory, the information retrieval rate being determined based at least in part on the monitored information delivery rate. The server processor may be capable of adjusting the determined information retrieval rate on a real time basis by monitoring the information delivery rate across the network from the server to the user on a real time basis; and determining the information retrieval rate on a real time basis based at least in part on the real time monitored information delivery rate.

In another respect, disclosed is a method of retrieving information from an information management system having at least one first processing engine coupled to at least one storage device and delivering the information across a network to a user from a second processing engine of the information management system coupled to the first processing engine. The method may include the steps of: monitoring an information delivery rate across the network from the second processing engine to the user; determining an information retrieval rate based at least in part on the monitored information delivery rate; using the second processing engine to retrieve information from the at least one storage device at the determined information retrieval rate and to store the retrieved information in a buffer/cache memory of the information management system; and delivering the stored information from the buffer/cache memory across the network to the user via the second processing engine. The first processing engine may include a storage management processing engine; and the first and second processing engines may be processing engines communicating as peers in a peer to peer environment via a distributed interconnect coupled to the processing engines. The method may further include adjusting the determined information retrieval rate on a real time basis by monitoring the information delivery rate across the network from the second processing engine to the user on a real time basis; and determining the information retrieval rate on a real time basis based at least in part on the real time monitored information delivery rate.

In another respect, disclosed is a network-connectable information management system that includes: at least one storage device; a first processing engine including a storage management processing engine coupled to the at least one storage device; a buffer/cache memory; a network interface connection to couple the information management system to a network; and a second processing engine coupled between the first processing engine and the network interface connection. The storage management processing engine may be capable of determining an information retrieval rate for retrieving information from the storage device and storing the information in the buffer/cache memory, the information retrieval rate being determined based at least in part on a monitored information delivery rate from the second processing engine to a user across the network that may be communicated to the storage management processing engine from the second processing engine. The storage management processing engine may be further capable of adjusting the determined information retrieval rate on a real time basis by monitoring the information delivery rate across the network from the second processing engine to the user on a real time basis; and determining the information retrieval rate on a real time basis based at least in part on the real time monitored information delivery rate.

### BRIEF DESCRIPTION OF THE DRAWINGS

FIG. 1 is a simplified representation of a with a network storage system coupled to a network via a network server according to one embodiment of the disclosed methods and systems.

FIG. 2 is a simplified representation of one or more storage devices coupled to a network via a network server according one embodiment of the disclosed methods and systems.

FIG. 3 is a representation of components of a content delivery system according to one embodiment of the disclosed content delivery system.

FIG. 4 is a representation of data flow between modules of a content delivery system of FIG. 3 according to one embodiment of the disclosed content delivery system.

### DESCRIPTION OF ILLUSTRATIVE EMBODIMENTS

Disclosed herein are methods and systems for optimizing information retrieval resources (e.g., buffer/cache memory performance, disk I/O resources, etc.) by intelligently managing information retrieval rates in information delivery environments. The disclosed methods and systems may be advantageously implemented in a variety of information delivery environments and/or with a variety of types of information management systems. Included among the examples of information management systems with which the disclosed methods and systems may be implemented are network content delivery systems that deliver non-continuous content (e.g., HTTP, FTP, etc.), that deliver continuous streaming content (e.g., streaming video, streaming audio, web proxy cache for Internet streaming, etc.), that delivery content or data objects of any kind that include multiple memory units, and/or that deliver over-size or very large data objects of any kind, such as over-size non-continuous data objects. As used herein an “over-size data object” refers to a data object that has an object size that is so large relative to the available buffer/cache memory size of a given information management system, that caching of the entire data object is not possible or is not allowed by policy within the given system. Examples of non-continuous over-size data objects include, but are not limited to, relatively large FTP files, etc.

The disclosed methods and systems may also be advantageously implemented in information delivery environments that deliver data objects that include multiple memory units (e.g. data files containing multiple data blocks) and/or multiple storage device blocks (e.g., data files containing multiple storage disk blocks). Such environments include those where a buffer/cache memory of a given information management system is required to simultaneously store memory units for multiple data files (each having multiple memory units and/or multiple storage device blocks) in order to simultaneously satisfy or fulfill requests for such files received from multiple users. In such an environment, it is possible that the total number of memory units associated with such multiple file requests may equal or exceed the available buffer/cache memory size of a given information management system.

Among the systems and methods disclosed herein are those suitable for operating network connected computing systems for information delivery including, for example, network endpoint systems. In this regard, examples of network endpoint systems include, but are not limited to, a wide variety of computing devices, including but not limited to, classic general purpose servers, specialized servers, network appliances, storage systems, storage area networks or other storage medium, content delivery systems, database management systems, corporate data centers, application service providers, home or laptop computers, clients, any other device that operates as an endpoint network connection, etc. A user system may also be a network endpoint, and its resources may typically range from those of a general purpose computer to the simpler resources of a network appliance. The various processing units of a network endpoint system may be programmed to achieve the desired type of endpoint.

Some embodiments of the network endpoint systems disclosed herein are network endpoint content delivery systems, e.g., network endpoint systems optimized for a content delivery application. Thus a content delivery system is provided as an illustrative example that demonstrates the structures, methods, advantages and benefits of the network computing system and methods disclosed herein. Content delivery systems (such as systems for serving streaming content, HTTP content, cached content, etc.) generally have intensive input/output demands. The network endpoint content delivery systems may be utilized in replacement of or in conjunction with traditional network servers. A “server” may be any device that delivers content, services, or both. For example, a content delivery server may receive requests for content from remote browser clients via the network, access a file system to retrieve the requested content, and deliver the content to the client. As another example, an applications server may be programmed to execute applications software on behalf of a remote client, thereby creating data for use by the client. Various server appliances are being developed and often perform specialized tasks.

Although exemplary embodiments of network endpoint systems are described and illustrated herein, the disclosed methods and systems may be implemented with any type of network connected system that retrieves and delivers information to one or more users (e.g., clients, etc.) of a network. One example of other types of network connected systems with which the disclosed systems and methods may be practiced are those that may be characterized as network intermediate node systems. Such systems are generally connected to some node of a network that may operate in some other fashion than an endpoint. Examples include network switches or network routers. Network intermediate node systems may also include any other devices coupled to intermediate nodes of a network. Another example of other types of network connected systems with which the disclosed systems and methods may be practiced are those hybrid systems that may be characterized as both a network intermediate node system and a network endpoint system. Such hybrid systems may perform both endpoint functionality and intermediate node functionality in the same device. For example, a network switch that also performs some endpoint functionality may be considered a hybrid system. As used herein such hybrid devices are considered to be a network endpoint system and are also considered to be a network intermediate node system.

The disclosed methods and systems thus may be advantageously implemented at any one or more nodes anywhere within a network including, but not limited to, at one or more nodes (e.g., endpoint nodes, intermediate nodes, etc.) present outside a network core (e.g., Internet core, etc.). Examples of intermediate nodes positioned outside a network core include, but are not limited to cache devices, edge serving devices, traffic management devices, etc. In one embodiment such nodes may be described as being coupled to a network at “non-packet forwarding” or alternatively at “non-exclusively packet forwarding” functional locations, e.g., nodes having functional characteristics that do not include packet forwarding functions, or alternatively that do not solely include packet forwarding functions, but that include some other form of information manipulation and/or management as those terms are described elsewhere herein.

Specific examples of suitable types of network nodes with which the disclosed methods and systems may be implemented include, but are not limited to, traffic sourcing nodes, intermediate nodes, combinations thereof, etc. Specific examples of such nodes include, but are not limited to, switches, routers, servers, load balancers, web-cache nodes, policy management nodes, traffic management nodes, storage virtualization nodes, node between server and switch, storage networking nodes, application networking nodes, data communication networking nodes, combinations thereof, etc. Further examples include, but are not limited to, clustered system embodiments described in the forgoing reference. Such clustered systems may be implemented, for example, with content delivery management (“CDM”) in a storage virtualization node to advantageously provide intelligent information retrieval and/or differentiated service at the origin and/or edge, e.g., between disk and a client-side device such as a server or other node.

Further, it will be recognized that the hardware and methods discussed herein may be incorporated into other hardware or applied to other applications. For example with respect to hardware, the disclosed system and methods may be utilized in network switches. Such switches may be considered to be intelligent or smart switches with expanded functionality beyond a traditional switch. Referring to content delivery applications described in more detail herein, a network switch may be configured to also deliver at least some content in addition to traditional switching functionality. Thus, though the system may be considered primarily a network switch (or some other network intermediate node device), the system may incorporate the hardware and methods disclosed herein. Likewise a network switch performing applications other than content delivery may utilize the systems and methods disclosed herein. The nomenclature used for devices utilizing the concepts of the present invention may vary. The network switch or router that includes the content delivery system disclosed herein may be called a network content switch or a network content router or the like. Independent of the nomenclature assigned to a device, it will be recognized that the network device may incorporate some or all of the concepts disclosed herein.

The disclosed hardware and methods also may be utilized in storage area networks, network attached storage, channel attached storage systems, disk arrays, tape storage systems, direct storage devices or other storage systems. In this case, a storage system having the traditional storage system functionality may also include additional functionality utilizing the hardware and methods shown herein. Thus, although the system may primarily be considered a storage system, the system may still include the hardware and methods disclosed herein. The disclosed hardware and methods of the present invention also may be utilized in traditional personal computers, portable computers, servers, workstations, mainframe computer systems, or other computer systems. In this case, a computer-system having the traditional computer system functionality associated with the particular type of computer system may also include additional functionality utilizing the hardware and methods shown herein. Thus, although the system may primarily be considered to be a particular type of computer system, the system may still include the hardware and methods disclosed herein.

As mentioned above, the benefits of the present invention are not limited to any specific tasks or applications. The content delivery applications described herein are thus illustrative only. Other tasks and applications that may incorporate the principles of the present invention include, but are not limited to, database management systems, application service providers, corporate data centers, modeling and simulation systems, graphics rendering systems, other complex computational analysis systems, etc. Although the principles of the present invention may be described with respect to a specific application/s, it will be recognized that many other tasks or applications may be performed with the hardware and methods.

Additional information on network environments, nodes and/or system configurations with which the disclosed methods and systems may be implemented include those nodes and configurations illustrated and described in relation to the provision of differentiated services in co-pending U.S. patent application Ser. No. 09/879,810 filed on Jun. 12, 2001 which is entitled SYSTEMS AND METHODS FOR PROVIDING DIFFERENTIATED SERVICE IN INFORMATION MANAGEMENT ENVIRONMENTS, and which has been incorporated herein by reference. Other examples of information delivery environments and/or information management system configurations with which the disclosed methods and systems may be advantageously employed include, but are not limited to, those described in the co-pending U.S. patent application Ser. No. 09/947,869 filed on Sep. 6, 2001 and entitled “SYSTEMS AND METHODS FOR RESOURCE MANAGEMENT IN INFORMATION STORAGE ENVIRONMENTS”, by Chaoxin C. Qiu et al.; in co-pending U.S. patent application Ser. No. 09/797,413 filed on Mar. 1, 2001 which is entitled NETWORK CONNECTED COMPUTING SYSTEM; and in co-pending U.S. patent application Ser. No. 09/797,200 filed on Mar. 1, 2001 which is entitled SYSTEMS AND METHODS FOR THE DETERMINISTIC MANAGEMENT OF INFORMATION; each of the foregoing applications being incorporated herein by reference.

In one embodiment, the disclosed methods and systems may be implemented to manage retrieval rates of memory units (e.g., for read-ahead buffer purposes) stored in any type of memory storage device or group of such devices suitable for providing storage and access to such memory units by, for example, a network, one or more processing engines or modules, storage and I/O subsystems in a file server, etc. Examples of suitable memory storage devices include, but are not limited to random access memory (“RAM”), magnetic or optical disk storage, tape storage, I/O subsystem, file system, operating system or combinations thereof.

Memory units may be organized and referenced within a given memory storage device or group of such devices using any method suitable for organizing and managing memory units. For example, a memory identifier, such as a pointer or index, may be associated with a memory unit and “mapped” to the particular physical memory location in the storage device (e.g. first node of Q₁^{used}=location FF00 in physical memory). In such an embodiment, a memory identifier of a particular memory unit may be assigned/reassigned within and between various layer and queue locations without actually changing the physical location of the memory unit in the storage media or device. Further, memory units, or portions thereof, may be located in non-contiguous areas of the storage memory. However, it will be understood that in other embodiments memory management techniques that use contiguous areas of storage memory and/or that employ physical movement of memory units between locations in a storage device or group of such devices may also be employed. Further, although described herein in relation to block level memory, it will be understood that embodiments of the disclosed methods and system may be implemented to deliver memory units on virtually any memory level scale including, but not limited to, file level units, bytes, bits, sector, segment of a file, etc.

The disclosed methods and systems may be implemented in combination with any memory management method, system or structure suitable for logically or physically organizing and/or managing memory. Examples of the many types of memory management environments with which the disclosed methods and systems may be employed include, but are not limited to, integrated logical memory management structures such as those described in U.S. patent application Ser. No. 09/797,198 filed on Mar. 1, 2001 which is entitled SYSTEMS AND METHODS FOR MANAGEMENT OF MEMORY; and in U.S. patent application Ser. No. 09/797,201 filed on Mar. 1, 2001 which is entitled SYSTEMS AND METHODS FOR MANAGEMENT OF MEMORY IN INFORMATION DELIVERY ENVIRONMENTS, each of which is incorporated herein by reference. Such integrated logical memory management structures may include, for example, at least two layers of a configurable number of multiple memory queues (e.g., at least one buffer layer and at least one cache layer), and may also employ a multi-dimensional positioning algorithm for memory units in the memory that may be used to reflect the relative priorities of a memory unit in the memory, for example, in terms of both recency and frequency. Memory-related parameters that may be may be considered in the operation of such logical management structures include any parameter that at least partially characterizes one or more aspects of a particular memory unit including, but are not limited to, parameters such as recency, frequency, aging time, sitting time, size, fetch (cost), operator-assigned priority keys, status of active connections or requests for a memory unit, etc.

Besides being suitable for use with integrated memory management structures having separate buffer and cache layers, the disclosed methods and systems may also be implemented with memory management configurations that organize and/or manage memory as a unitary pool, e.g., implemented to perform the duties of buffer and/or cache and/or other memory task/s. In one exemplary embodiment, such memory management structures may be implemented, for example, by a single processing engine in a manner such that read-ahead information and cached information are simultaneously controlled and maintained together by the processing engine. In this regard, “buffer/cache” is used herein to refer to any type of memory or memory management scheme that may be employed to store retrieved information prior to transmittal of the stored information for delivery to a user. Examples include, but are not limited to, memory or memory management schemes related to unitary memory pools, integrated or partitioned memory pools, memory pools comprising two or more physically separate memory media, memory capable of performing cache and/or buffer (e.g., read-ahead buffer) tasks, hierarchial memory structure, etc.

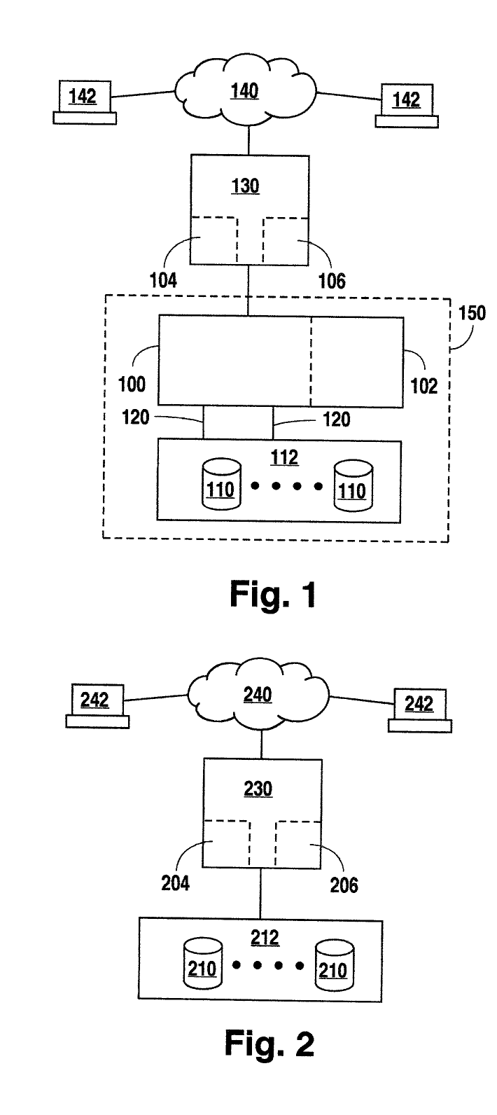

FIG. 1 is a simplified representation of one exemplary embodiment of the disclosed methods and systems, for example, as may be employed in conjunction with a network storage system 150 (e.g., network endpoint storage system) that is coupled to a network 140 via a network server 130. In the embodiments illustrated herein, network 140 may be any type of computer network suitable for linking computing systems. Examples of such networks include, but are not limited to, the public internet, a private intranet network (e.g., linking users and hosts such as employees of a corporation or institution), a wide area network (WAN), a local area network (LAN), a wireless network, any other client based network or any other network environment of connected computer systems or online users, etc. Thus, the data provided from the network 140 may be in any networking protocol. In one embodiment, network 140 may be the public internet that serves to provide access to content stored on storage devices 110 of storage system 150 by multiple online users 142 that utilize internet web browsers on personal computers operating through an internet service provider. In this case the data is assumed to follow one or more of various Internet Protocols, such as TCP/IP, UDP, HTTP, RTSP, SSL, FTP, etc. However, the same concepts apply to networks using other existing or future protocols, such as IPX, SNMP, NetBios, Ipv6, etc. The concepts may also apply to file protocols such as network file system (NFS) or common internet file system (CIFS) file sharing protocol.

In the embodiment of FIG. 1, multiple storage devices 110 are shown configured in a storage device array 112 coupled to a network server 130 via storage management processing engine 100 having buffer/cache memory 102. Storage management processing engine 100 may be any hardware or hardware/software subsystem, e.g., configuration of one or more processors or processing modules, suitable for effecting delivery of requested content from storage device array 112 in response to processed requests received from network server 130 in a manner as described herein. In one exemplary embodiment, storage management processing engine 100 may include one or more Motorola POWER PC-based processor modules. It will be understood that in various embodiments a storage management processing engine 100 may be employed with a variety of storage devices other than disk drives (e.g., solid state storage, storage devices described elsewhere herein, or any other media suitable for storage of data) and may be programmed to request and receive data from these other types of storage. It will also be understood that each storage device 110 may be a single storage device (e.g., single disk drive) or a group of storage devices (e.g., partitioned group of disk drives), and that combinations of single storage devices and storage device groups may be coupled to storage management processing engine 100. In the illustrated embodiment, storage devices 100 (e.g., disk drives) may be controlled at the disk level by storage management processing engine 100, and/or may be optionally partitioned into multiple sub-device layers (e.g., sub-disks) that are controlled by single storage processing engine 100.

Optional buffer/cache memory 106 may be present in server 130, either in addition to or as an alternative to buffer/cache memory 102 of storage processing engine 100. In this regard, buffer/cache memory 106 may be resident in the operating system of server 130, and/or may be provided by an adapter card coupled to said server. Such an adapter card may also include one or more processors capable of performing, for example, RAID controller tasks. Additional discussion of buffer cache memory implemented in a server or storage adapter coupled to the server may be found below in relation to buffer/cache memory 206 of FIG. 2.

Although multiple storage devices 110 are illustrated in FIG. 1, it is also possible that only one storage device may be employed in a similar manner, and/or that multiple groups or arrays of storage devices may be implemented in the embodiment of FIG. 1 in addition to, or as an alternative to, multiple storage devices 110. It will also be understood that one or more storage devices 110 and/or storage processing engine/s 100 may be configured internal or external to the chassis of server 130. However, in the embodiment of FIG. 1 storage system 150 is configured external to server 130 and includes storage management processing engine 100 coupled to storage devices 110 of storage device array 112 using, for example, fiber channel loop 120 or any other suitable interconnection technology. Storage management processing engine 100 is in turn shown coupled to network 140 via server 130. In operation, server 130 communicates information requests to storage management processing engine 100 of storage system 150, which is responsible for retrieving and communicating requested information to server 130 for delivery to users 142. In this regard, server 130 may be configured to function in a manner that is unaware of the origin of the requested information supplied by storage system 150, i.e., whether requested information is forwarded to server 130 from buffer/cache memory 102 or directly from one or more storage devices 110.

In one implementation of the embodiment of FIG. 1, storage management processing engine 100 may be, for example, a RAID controller and storage device array 112 may be a RAID disk array, the two together comprising a RAID storage system 150, e.g., an external RAID cabinet. However, it will be understood with benefit of this disclosure that an external storage system 150 may be a non-RAID external storage system including any suitable type of storage device array 112 (e.g., JBOD array, etc.) in combination with any type of storage management processing engine 100 (e.g., a storage subsystem, etc.) suitable for controlling the storage device array 112. Furthermore, it will be understood that an external storage system 150 may include multiple storage device arrays 112 and/or multiple storage management processing engines 100, and/or may be coupled to one or more servers 130, for example in a storage area network (SAN) or network attached storage (NAS) configuration.

In the embodiment illustrated in FIG. 1, storage management processing engine 100 includes buffer/cache memory 102, e.g., for storing cached and/or read-ahead buffer information retrieved from storage devices 110. However, it will be understood that buffer/cache memory 102 may be provided in any suitable manner for use or access by storage management processing engine 100 including, but not limited to, internal to storage processing engine 100, external to storage processing engine 100, external to storage system 150, combinations thereof, etc. In one exemplary embodiment, storage management processing engine 100 may employ buffer/cache algorithms to manage buffer/cache memory 102. In this regard, storage management processing engine 100 may act as a RAID controller and employ buffer/cache algorithms that also include one or more RAID algorithms. However, it will be understood that buffer/cache algorithms without RAID functionality may also be employed.

Still referring to FIG. 1, information (e.g., streaming content) is delivered by server 130 across network 140 to one or more users 142 (e.g., content viewers) at an information delivery rate for each such user. Such an information delivery rate may have a maximum value that may be dependent in this case, for example, on the lesser of the information delivery rate sustainable by each end user 142, and the information delivery rate sustainable by the network 140. Although individual users 142 are illustrated in FIG. 1, it will be understood that the disclosed methods and systems for intelligent information retrieval may be practiced in a similar manner where information delivery rates are monitored, and information retrieval rates determined, for groups of individual users 142.

The information delivery rate for each user 142 may vary over time, and may be tracked or monitored for each end user in real time and/or on a historical basis in any suitable manner. For example, server 130 may include one or more server processor/s 104 capable of monitoring the information delivery rate of information across network 140 to one or more users 142 which may be, for example, viewers of streaming content delivered by server 130. In such an exemplary embodiment, server processor/s 104 may monitor the information delivery rate (e.g., continuous streaming media data consumption rate) for one or more clients/user using any suitable methodology including, but not limited to, by using appropriate counters, I/O queue depth counters, combination thereof, etc. It will be understood with benefit of this disclosure that any alternate system configuration suitable for monitoring information delivery rate may also or additionally be employed. For example, monitoring tasks may be performed by a monitoring agent, processing engine, or separate information management system external to server 130 and/or internal to storage system 150. Additional information on systems and methods that may be suitably employed for monitoring information delivery rates may be found, for example, in co-pending U.S. patent application Ser. No. 09/797,100 filed on Mar. 1, 2001 which is entitled SYSTEMS AND METHODS FOR THE DETERMINISTIC MANAGEMENT OF INFORMATION; and in co-pending U.S. patent application Ser. No. 09/947,869 filed on Sep. 6, 2001 and entitled “SYSTEMS AND METHODS FOR RESOURCE MANAGEMENT IN INFORMATION STORAGE ENVIRONMENTS”, by Chaoxin C. Qiu et al.; the disclosures of each of which has been incorporated herein by reference.

Monitored information delivery rates may be communicated from server processor/s 104 to storage management processing engine 100 in any suitable manner. Storage management processing engine may then use monitored information delivery rate for a given user 142 to determine a corresponding information retrieval rate at which information is retrieved from storage devices 110 for storage in buffer/cache memory 102 and subsequent delivery to the given user 142 associated with a particular monitored information delivery rate. Thus, information retrieval rate for a given user 142 may be determined based on monitored information delivery rate for the same given user 142 in a manner such that the next required memory unit is already retrieved and stored in buffer/cache memory 102 prior to the time it is needed for delivery to the user 142.

As described elsewhere herein, the disclosed methods and systems may be employed for the intelligent retrieval of both continuous and non-continuous type information, and with information that is deposited or stored in a variety of different ways or using a variety of different schemes. For example, information may be deposited on one or more storage devices 110 as contiguous memory units (e.g., data blocks), or as non-continuous memory units. In one embodiment, continuous media files (e.g., for audio or video streams) may be deposited by a file system as contiguous data blocks on one or more storage devices. In such a case, server 130 may communicate one or more information retrieval parameters to storage processing engine 100 to achieve intelligent retrieval of information from storage devices 110 based at least in part on monitored information delivery rate to one or more users 142. Examples of information retrieval parameters include, but are not limited to, monitored, negotiated or protocol-determined information delivery rate to client users 142, starting memory unit (e.g., data block) for retrieved information, number of memory units (e.g., data blocks) identified for retrieval, file size, class of service and QoS requirement, etc. In addition to monitored information delivery rate, other exemplary types of information delivery rate information that may be communicated to storage processing engine 100 include, for example, continuous content delivery rate that is negotiated between server 130 and client user/s 142, non-continuous content delivery rate set using TCP (best possible rate) or other protocol.

In the embodiment of FIG. 1, storage management processing engine 100 may determine information retrieval rates based on corresponding monitored information delivery rates using, for example, algorithms appropriate to the desired relationship between a given monitored information delivery rate and a corresponding information retrieval rate determined therefrom, referred to herein as “information retrieval relationship”. In one exemplary embodiment, information retrieval rate for a particular user 142 may be determined as a rate based at least in part on the monitored information delivery rate to the particular user 142. For example, information may be retrieved for a particular user 142 at a rate equal to the monitored information delivery rate to the particular user 142. Alternatively, information may be retrieved for a particular user 142 at a rate that is determined as a function of the monitored information delivery rate (e.g. determined by mathematical function or other mathematical operation performed using the monitored information delivery rate including, but not limited to, the resulting product, sum, quotient, etc. of the information delivery rate with a constant or variable value).

One exemplary implementation possible for retrieving contiguously placed data blocks (e.g., such as streaming audio or video files) with the embodiment of FIG. 1 may proceed as follows. Server 130 passes or otherwise communicates to storage processing engine 100 monitored information delivery rate (e.g., 150 kilobits/second), starting data block, and optionally a number of data blocks for retrieval (e.g., 1000 data blocks). Upon receipt of this information, storage processing engine 100 then begins by reading the first set of sequential data blocks into buffer/cache memory 102 at an information retrieval rate determined based at least in part on the monitored information delivery rate in a manner as previously described, and by delivering the data blocks to server 130 from buffer/cache memory 102 as requested by server 130. In those implementations where a number of data blocks are communicated by server 130 to storage processing engine 100, the first set of sequential data blocks may be based on the starting data block and this communicated number of data blocks. In other implementations, the first set of sequential data blocks may be based on the starting data block and on a default number of read-ahead data blocks, e.g., in those cases where a number of data blocks are not communicated by server 130 to storage processing engine 100.

In some implementations, the number of sequential data blocks in each retrieval may be constant for the life of each communication session, optimized based on other constraints, such as the memory size and disk IOPS. In other implementations, the number of sequential data blocks in each retrieval may be adjusted during the life of each communication session, optimized based on other constraints, such as the memory size and disk IOPS and adjusted based on the internal workload changes. In yet other implementations, the number of sequential data blocks in retrieval may be adjusted with a smaller number at the beginning of the connection session (even though it may not be optimized) as necessary due to the response time constraints.

Storage processing engine 100 then continues by reading the following sets of sequential data blocks into buffer/cache memory 102 at the determined information delivery rate while at the same time delivering each sequential set of data blocks to server 130 from buffer/cache memory 102 as server 130 requests them. It will be understood that the forgoing description is exemplary only, and that the disclosed methods and systems of intelligent information retrieval may be implemented in any manner suitable for retrieving information from one or more storage devices 110 at a rate determined based at least in part on monitored information delivery rate to one or more users 142. For example, data blocks may be retrieved at a determined rate from one or more storage devices by a storage processing engine and deposited directly into server memory (e.g., RAM) using “VIA” protocol or “INFINIBAND”.

In a further possible embodiment, information delivery rate information for a given user may be monitored and communicated from server processor/s 104 to storage management processing engine 100 on a real time basis (e.g., continuously or intermittently—such as monitored from once about every 3 seconds to once about every 5 seconds, etc.). Storage management processing engine may then use such real time monitored information delivery rates for a given user 142 to adaptively re-determine or adjust in real time the corresponding determined information retrieval rates at which information is retrieved from storage devices 110 for storage in buffer/cache memory 102 and subsequent delivery to the given user 142 associated with a particular monitored information delivery rate. So adjusting determined information retrieval rate on a real time basis allows information retrieval rates to be advantageously adapted or optimized to fit changing network conditions (e.g. to adjust to degradation or improvements in network delivery bandwidth, to adjust to changing front end delivery rate requirements, etc.).

The embodiment of FIG. 1 may also be employed to retrieve non-contiguously placed data blocks in a manner similar to retrieving contiguously placed data blocks. In such a case, server 130 may pass or otherwise communicate to storage processing engine 100 a monitored information delivery rate, a list of data blocks that are to be retrieved in order, and optionally a number of data blocks for retrieval. Upon receipt of this information, storage processing engine 100 begins by reading a first set of data blocks from the list of data blocks to be retrieved in order (e.g., a set of blocks based on an optional communicated number of data blocks or on a default number of read-ahead data blocks) into buffer/cache memory 102 at an information retrieval rate determined based at least in part on the monitored information delivery rate in a manner as previously described. Storage processing engine 100 continues by delivering the set of data blocks to server 130 from buffer/cache memory 102 as requested by server 130. Storage processing engine 100 then continues by reading additional sets of the listed data blocks into buffer/cache memory 102 at the determined information delivery rate while at the same time delivering each retrieved set of data blocks to server 130 from buffer/cache memory 102 as server 130 requests them.

It will be understood that the disclosed systems and methods may be implemented in conjunction with any contiguous or non-contiguous method suitable for storing information on storage media, such as one or more storage devices. In one exemplary embodiment, two or more relatively small and separate data objects (e.g., separate HTTP data files of less than or equal to about 2 kilobytes in size) that are related to one another by one or more inter-data object relationships may be stored contiguous to one another on a storage device/s so that they may be read together in a manner that reduces storage retrieval overhead. One example of such an inter-data object relationship is multiple separate HTTP data files that are retrieved together when a single web page is opened. In another exemplary embodiment, a non-contiguously placed data object may be stored in storage device block sizes (e.g., disk blocks) that are equal to or greater in than (or that are relatively large when compared to) the read-ahead size in order to increase the hit ratio of useful data to total data read. Stated another way, a non-contiguously placed data object may be retrieved using a read ahead size that is equal to or less than (or that is relatively small when compared to) the storage device block size of the non-contiguously placed data object. For example, a non-contiguous file may be stored in disk blocks of 512 kilobytes, and then retrieved using a read-ahead size of 128 kilobytes. Advantageously, the useful data hit ratio of such an embodiment will be greater than for a non-contiguous file stored in disk blocks of 64 kilobytes that are retrieved using a read-ahead size of 128 kilobytes.

FIG. 2 is a simplified representation of just one of the possible alternate embodiments of the disclosed methods and systems, for example, as may be employed in conjunction with one or more storage devices 210 coupled to a network 240 via a network server 230. Network 240 may be any type of computer network suitable for linking computing systems such as, for example, those described in relation to FIG. 2. In the embodiment of FIG. 2, multiple storage devices 210 are shown configured in a storage device array 212 (e.g., just a bunch of disks or “JBOD” array) coupled to a network server 230. In this regard, storage devices 210 may be configured internal and/or external to the chassis of server 230. Although multiple storage devices 210 are illustrated in FIG. 2, it is also possible that only one storage device may be coupled to server 230 in a similar manner.

As shown in FIG. 2, server 230 includes buffer/cache memory 206 for storing cached and/or read-ahead buffer information retrieved from storage devices 210. Buffer/cache memory 206 may be resident in the memory of server 230 and/or may be provided by one or more storage adapter cards installed in server 230. Buffer/cache functionality may reside in the operating system of server 230 and be implemented by buffer/cache algorithms in the software stack which are run by one or more server processor/s 204 present within server 230. Alternatively, buffer/cache algorithms may be implemented below the operating system by a processor running on a storage adapter or by a separate storage management processing engine (e.g., intelligent storage blade card) installed in server 230. In one exemplary embodiment, buffer/cache algorithms may include one or more RAID algorithms. However, it will be understood that buffer/cache algorithms without RAID functionality may also be employed in the practice of the disclose methods and systems.

As with the embodiment of FIG. 1, information (e.g., streaming content) is delivered by server 230 across network 240 to one or more users 242 (e.g., content viewers) at a information delivery rate that may be tracked or monitored for each user 242 or group of users 242 in real time and/or on a historical basis. For example, one or more server processor/s 204 of server 230 may monitor the information delivery rate of one or more users 242 using any suitable methodology, for example, by counters, queue depths, file access tracking, logical volume tracking, etc. Similar to the manner described in relation to FIG. 1, monitored information delivery rate/s may then be used to determine corresponding information retrieval rate/s at which information is retrieved from storage devices 210 for storage in buffer/cache memory 206 and subsequent delivery to the respective user 242 associated with a particular monitored information delivery rate, for example, such that the next required memory unit is already retrieved and stored in buffer/cache memory 206 prior to the time it is needed for delivery to the user 242.

In the embodiment of FIG. 2, server processor/s 242 may determine information retrieval rates based on corresponding monitored information delivery rates using, for example, algorithms appropriate to the desired relationship between a given information retrieval rate and its corresponding monitored information delivery rate. Alternatively, monitoring of information delivery rate and determination of information retrieval rates may be made by a processor running on a storage adapter or, when present, by a separate storage management processing engine (e.g., intelligent storage blade) installed in server 230. As a further alternative, separate tasks of information delivery rate monitoring and information retrieval rate determination may be performed by any suitable combination of separate processors or processing engines (e.g. information delivery rate monitoring performed by server processor, and corresponding information retrieval rate determination performed by storage adapter processor or storage management processing engine, etc.).

As described in relation to the embodiment of FIG. 1, information may be retrieved for a particular user 242 of the embodiment of FIG. 2 at a rate based at least in part on the monitored information delivery rate to the particular user 242. For example, information may be retrieved for a particular user 242 at a rate equal to the monitored information delivery rate to the particular user 242, or at a rate that is determined as a function of the monitored information delivery rate. Furthermore, in a manner similar to that described in relation to the embodiment of FIG. 1, real time monitoring of information delivery rates may be implemented and corresponding determined information retrieval rates may be adjusted on a real time basis to fit changing network conditions.

Although FIGS. 1 and 2 illustrate storage management processing engines in communication with a network via a separate network server, it will be understood that other configurations are possible. For example, a storage management processing engine may be present as a component of a network connected information management system (e.g., endpoint content delivery system) that is coupled to the network via one or more other processing engines of such an information management system, e.g., application processing engine/s, network interface processing engine/s, network transport / protocol processing engine/s, etc. Examples of such information management systems are described in co-pending U.S. patent application Ser. No. 09/797,200 filed on Mar. 1, 2001 which is entitled SYSTEMS AND METHODS FOR THE DETERMINISTIC MANAGEMENT OF INFORMATION by Johnson et al., the disclosure of which is incorporated herein by reference.

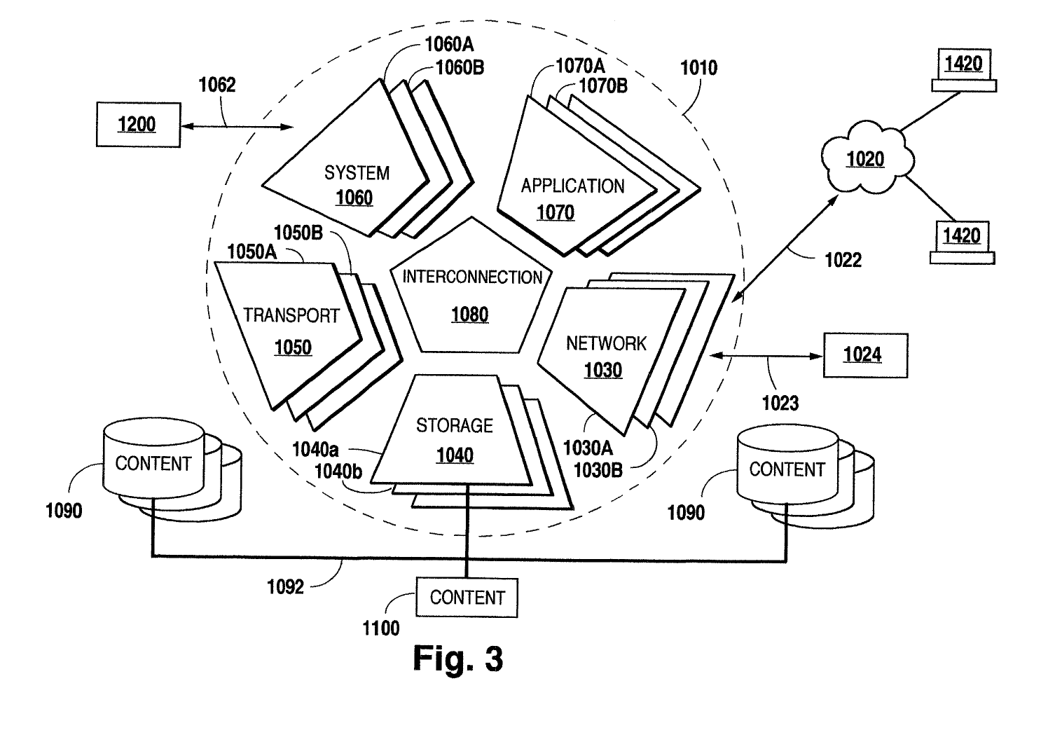

For example, FIG. 3 is a representation of one embodiment of a content delivery system 1010, for example as may be employed as a network endpoint system in connection with a network 1020. Network 1020 may be any type of computer network suitable for linking computing systems, such as those exemplary types of networks 140 described in relation to FIGS. 1 and 2. Examples of content that may be delivered by content delivery system 1010 include, but are not limited to, static content (e.g., web pages, MP3 files, HTTP object files, audio stream files, video stream files, etc.), dynamic content, etc. In this regard, static content may be defined as content available to content delivery system 1010 via attached storage devices and as content that does not generally require any processing before delivery. Dynamic content, on the other hand, may be defined as content that either requires processing before delivery, or resides remotely from content delivery system 1010. As illustrated in FIG. 3, content sources may include, but are not limited to, one or more storage devices 1090 (magnetic disks, optical disks, tapes, storage area networks (SAN's), etc.), other content sources 1100, third party remote content feeds, broadcast sources (live direct audio or video broadcast feeds, etc.), delivery of cached content, combinations thereof, etc. Broadcast or remote content may be advantageously received through second network connection 1023 and delivered to network 1020 via an accelerated flowpath through content delivery system 1010. As discussed below, second network connection 1023 may be connected to a second network or application 1024 as shown. Alternatively, both network connections 1022 and 1023 may be connected to network 1020.

As shown in FIG. 3, one embodiment of content delivery system 1010 includes multiple system engines 1030, 1040, 1050, 1060, and 1070 communicatively coupled via distributive interconnection 1080. In the exemplary embodiment provided, these system engines operate as content delivery engines. As used herein, “content delivery engine” generally includes any hardware, software or hardware/software combination capable of performing one or more dedicated tasks or sub-tasks associated with the delivery or transmittal of content from one or more content sources to one or more networks. In the embodiment illustrated in FIG. 3 content delivery processing engines (or “processing blades”) include network interface processing engine 1030, storage processing engine 1040, network transport / protocol processing engine 1050 (referred to hereafter as a transport processing engine), system management processing engine 1060, and application processing engine 1070. Thus configured, content delivery system 1010 is capable of providing multiple dedicated and independent processing engines that are optimized for networking, storage and application protocols, each of which is substantially self-contained and therefore capable of functioning without consuming resources of the remaining processing engines.

Storage management engine 1040 may be any hardware or hardware/software subsystem suitable for effecting delivery of requested content from content sources (for example content sources 1090 and/or 1100) in response to processed requests received from application processing engine 1070. It will also be understood that in various embodiments a storage management engine 1040 may be employed with content sources other than disk drives (e.g., solid state storage, the storage systems described above, or any other media suitable for storage of data) and may be programmed to request and receive data from these other types of storage. Application processing engine 1070 may be provided in content delivery system 1010 for application processing, and may be, for example, any hardware or hardware/software subsystem suitable for session layer protocol processing (e.g., HTTP, RTSP streaming, etc.) of content requests received from network transport processing engine 1050. Transport processing engine 1050 may be provided for performing network transport protocol sub-tasks, such as processing content requests received from network interface engine 1030. Transport processing engine 1050 may be employed to perform transport and protocol processing, and may be any hardware or hardware/software subsystem suitable for TCP/UDP processing, other protocol processing, transport processing, etc. Network interface processing engine 1030 may be any hardware or hardware/software subsystem suitable for connections utilizing TCP (Transmission Control Protocol) IP (Internet Protocol), UDP (User Datagram Protocol), RTP (Real-Time Transport Protocol), Internet Protocol (IP), Wireless Application Protocol (WAP) as well as other networking protocols. Thus network interface processing engine 1030 may be suitable for handling queue management, buffer management, TCP connect sequence, checksum, IP address lookup, internal load balancing, packet switching, etc.

System management (or host) engine 1060 may be present to perform system management functions related to the operation of content delivery system 1010. Examples of system management functions include, but are not limited to, content provisioning/updates, comprehensive statistical data gathering and logging for sub-system engines, collection of shared user bandwidth utilization and content utilization data that may be input into billing and accounting systems, “on the fly” ad insertion into delivered content, customer programmable sub-system level quality of service (“QoS”) parameters, remote management (e.g., SNMP, web-based, CLI), health monitoring, clustering controls, remote/local disaster recovery functions, predictive performance and capacity planning, etc. In one embodiment, content delivery bandwidth utilization by individual content suppliers or users (e.g., individual supplier/user usage of distributive interchange and/or content delivery engines) may be tracked and logged by system management engine 1060. Distributive interconnection 1080 may be any multi-node I/O interconnection hardware or hardware/software system suitable for distributing functionality by selectively interconnecting two or more content delivery engines of a content delivery system including, but not limited to, high speed interchange systems such as a switch fabric or bus architecture. Examples of switch fabric architectures include cross-bar switch fabrics, Ethernet switch fabrics, ATM switch fabrics, etc. Examples of bus architectures include PCI, PCI-X, S-Bus, Microchannel, VME, etc.

It will be understood with benefit of this disclosure that the particular number and identity of content delivery engines illustrated in FIG. 3 are illustrative only, and that for any given content delivery system 1010 the number and/or identity of content delivery engines may be varied to fit particular needs of a given application or installation. Thus, the number of engines employed in a given content delivery system may be greater or fewer in number than illustrated in FIG. 3, and/or the selected engines may include other types of content delivery engines and/or may not include all of the engine types illustrated in FIG. 3. In one embodiment, the content delivery system 1010 may be implemented within a single chassis, such as for example, a 2U chassis.

Content delivery engines 1030, 1040, 1050, 1060 and 1070 are present to independently perform selected sub-tasks associated with content delivery from content sources 1090 and/or 1100, it being understood however that in other embodiments any one or more of such subtasks may be combined and performed by a single engine, or subdivided to be performed by more than one engine. In one embodiment, each of engines 1030, 1040, 1050, 1060 and 1070 may employ one or more independent processor modules (e.g., CPU modules) having independent processor and memory subsystems and suitable for performance of a given function/s, allowing independent operation without interference from other engines or modules. Advantageously, this allows custom selection of particular processor-types based on the particular sub-task each is to perform, and in consideration of factors such as speed or efficiency in performance of a given subtask, cost of individual processor, etc. The processors utilized may be any processor suitable for adapting to endpoint processing. Any “PC on a board” type device may be used, such as the x86 and Pentium processors from Intel Corporation, the SPARC processor from Sun Microsystems, Inc., the PowerPC processor from Motorola, Inc. or any other microcontroller or microprocessor. In addition, network processors may also be utilized. The modular multi-task configuration of content delivery system 1010 allows the number and/or type of content delivery engines and processors to be selected or varied to fit the needs of a particular application.

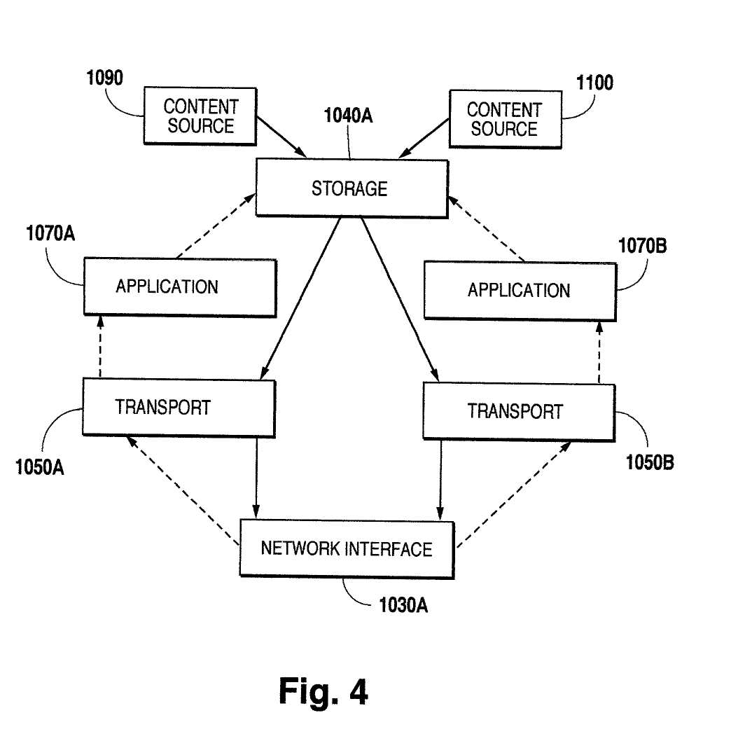

FIG. 4 illustrates one exemplary data and communication flow path configuration among content delivery modules of one embodiment of content delivery system 1010. The illustrated embodiment of FIG. 4 employs two network application processing modules 1070a and 1070b, and two network transport processing modules 1050a and 1050b that are communicatively coupled with single storage management processing module 1040a and single network interface processing module 1030a. Storage management processing module may be, for example, a hardware or hardware/software subsystem such as that described in relation to storage management processing engine 100 of FIG. 1. The storage management processing module 1040a is in turn coupled to content sources 1090 and 1100. In FIG. 4, inter-processor command or control flow (i.e. incoming or received data request) is represented by dashed lines, and delivered content data flow is represented by solid lines.

Command and data flow between modules may be accomplished through the distributive interconnection 1080 (not shown), for example a switch fabric. It will be understood that the embodiment of FIG. 4 is exemplary only, and that any alternate configuration of processing modules suitable for the retrieval of and delivery of information may be employed including, for example, alternate combinations of processing modules, alternate types of processing modules, additional or fewer number of processing modules (including only one application processing module and/or one network processing module, etc. Further, it will be understood that alternate interprocessor command paths and/or delivered content data flow paths may be employed.

As shown in FIG. 4, a request for content is received and processed by network interface processing module 1030a and then passed on to either of network transport processing modules 1050a or 1050b for TCP/UDP processing, and then on to respective application processing modules 1070a or 1070b, depending on the transport processing module initially selected. After processing by the appropriate network application processing module, the request is passed on to storage management processor 1040a for processing and retrieval of the requested content from appropriate content sources 1090 and/or 1100. Information delivery rates to one or more users 1420 may be monitored by one or more of content delivery engines of content delivery system 1010, for example, by one or more of the processing modules of FIG. 4 (e.g., application processing module 1070), or by a separate processing engine coupled to system 1010. Monitored information delivery rate may then be passed on or communicated to storage processing module 1040. Storage processing module 1040 may then use monitored information delivery rate for a given user 1420 to determine a corresponding information retrieval rate at which information is retrieved from storage devices of content source 1090 and/or 1100 for storage in buffer/cache memory of storage processing module 1040 subsequent delivery to the given user 1420 associated with a particular monitored information delivery rate. Thus, in a manner similar to that described in relation to the embodiments of FIGS. 1 and 2, information retrieval rate for a given user 1420 may be determined based at least in part on monitored information delivery rate for the same given user 1420 in a manner according to a desired relationship between information delivery and information retrieval rates, e.g., such that the next required memory unit is already retrieved and stored in buffer/cache memory of storage processing module 1040 prior to the time it is needed for delivery to the user 1420. Furthermore, in a manner similar to that previously described in relation to FIGS. 1 and 2, real time monitoring of information delivery rates may be implemented using the embodiment of FIG. 3 and corresponding determined information retrieval rates may be adjusted on a real time basis to fit changing network conditions.

It will be understood that the above description relating to the embodiment of FIGS. 3 and 4 is exemplary only, and that alternative configurations and/or methodology may be employed. For example, information retrieval rates may be determined by any suitable processing module of system 1010 other than storage processing module 1040 based at least in part on corresponding monitored information delivery rates. Furthermore, buffer/cache memory may be present in other processing modules besides storage processing module 1040.

The disclosed methods and systems may be advantageously implemented with other features designed to optimize information delivery performance. For example, protocol information (e.g., HTTP headers, RTSP headers, etc.) may be passed to a storage management processing engine that is capable of encapsulating data as it is requested and passing it directly to a TCP/IP processing engine in a manner so as to achieve an accelerated network fastpath between storage and network. Examples of an implementation of such an accelerated network fastpath may be found described in co-pending U.S. patent application Ser. No. 09/797,200 filed on Mar. 1, 2001 which is entitled SYSTEMS AND METHODS FOR THE DETERMINISTIC MANAGEMENT OF INFORMATION by Johnson et al., which has been incorporated herein by reference.

Although a network fastpath may be implemented in conjunction with any suitable embodiment described herein, FIG. 4 illustrates it applied to the exemplary content delivery endpoint system described above. As shown in FIG. 4, storage management processing module 1040a may respond to a request for content by forwarding the requested content directly to one of network transport processing modules 1050a or 1050b, utilizing the capability of distributive interconnection 1080 to bypass network application processing modules 1070a and 1070b. The requested content may then be transferred via the network interface processing module 1030a to the external network 1020. In an alternative embodiment, the content may be delivered from the storage management processing module to the application processing module rather than bypassing the application processing module. This data flow may be advantageous if additional processing of the data is desired.

For example, it may be desirable to decode or encode the data prior to delivery to the network.

Although described in relation to continuous data objects or files, it will be understood that the embodiments of FIGS. 1-3 may also be employed to retrieve and deliver over-sized non-continuous data objects and/or non-continuous data objects that include multiple memory units (e.g., using HTTP, FTP or any other suitable file transfer protocols). For example, depending on the filesystem employed, server 230 of FIG. 2 may pass to storage processing engine 200 either a list of blocks (e.g., in the case of non-contiguous filesystems), or a start block and number of blocks (e.g., in the case of a contiguous filesystem), along with monitored information delivery rate, and any other selected optional information. As with continuous files, storage processing engine 200 may pull the specified blocks from disk into its buffer/cache memory 206 at an information retrieval rate determined based at least in part on the monitored information delivery rate, ensuring that data blocks will always be memory-resident as they are requested by server 230.

It will be understood with benefit of this disclosure that disclosed methods and systems may implemented to retrieve and deliver data objects or files of any kind and in any environment in which read-ahead functionality is desirable. However, in some environments it may be desirable to selectively employ the disclosed intelligent information retrieval for read-ahead purposes only for certain types of data objects or files having characteristics identifiable by server 230, storage processing engine 200, or a combination thereof. For example, read-ahead functionality may not be desirable for the retrieval and delivery of relatively small HTTP objects or small files (e.g. data files having a size less than the block or stripe size). In such a case, the disclosed methods and systems may be implemented so that intelligent information retrieval is not implemented for such files. In one exemplary implementation, server 230 may be configured to identify a request for a data file having a size less than the block or stripe size. When such a request is identified, server 230 may respond by not communicating a monitored information delivery rate to storage processing engine 200, and/or by communicating to storage processing engine 200 an indicator or tag that rate-shaping is not required for a given requested data object or file. In either case, storage processing engine 200 responds by not performing read-ahead tasks for the retrieval of the given data object or file.

In addition to embodiments directed towards the delivery of information to one or more users in a manner that is free or substantially free of interruption or hiccups, the disclosed methods and systems for intelligent information retrieval may alternatively or additionally employed to accomplish any other objective that relates to information retrieval optimization and/or information retrieval policy implementation. Examples of such other embodiments include, but are not limited to, implementations directed towards the efficient use of available buffer/cache memory, and implementations to facilitate information retrieval and delivery that is differentiated, for example, among a plurality of different users, among a plurality of different information request types, etc.

For example, in one embodiment the disclosed methods and systems may be used to increase the efficiency of buffer/cache memory use by tailoring or customizing the amount or size of memory (e.g., read-ahead buffer memory) that is consumed over time to service a given information request. In this regard, read-ahead memory size and other information retrieval resources utilized for a given user or a given request may vary based on the information retrieval rate for that given user or request. Because the disclosed methods and systems utilize an information retrieval rate that is determined based at least in part on an information delivery rate that is tracked or monitored on a per-user or per-request basis, it is possible to effectively allocate information retrieval resources (e.g., cache/buffer memory, storage device IOPS, storage device read head utilization, storage processor utilization, etc.) among a plurality of users or requests in a manner that is proportional or otherwise based at least in part on the actual monitored delivery rate for each respective user or request. Advantageously, the information retrieval relationship (i.e., relationship between monitored information delivery rate and the respective determined information retrieval rate) may be formulated or set in a manner that ensures that a sufficient amount of information retrieval resources are allocated to service a given user or request at a suitable determined information retrieval rate, while at the same time minimizing or substantially eliminating the allocation of information retrieval resources in excess of the amount required to delivery information to the given user without interruption or hiccups. Because allocation of excess information retrieval rates are avoided, a given amount of information retrieval resources may be optimized to serve a greater number of simultaneous users or requests without substantial risk of information delivery service degradation due to interruptions or hiccups.

In yet another embodiment, the disclosed methods and systems for intelligent information retrieval may be employed to implement differentiated service such as differentiated information service and/or differentiated business service. For example, it is possible that the information retrieval rate between a monitored information delivery rate and corresponding determined information retrieval rate for particular users may vary, for example, based on the availability of buffer/cache memory; based on one or more priority-indicative parameters (e.g., service level agreement [“SLA”] policy, class of service [“CoS”], quality of service [“QoS”], etc.) associated with an individual subscriber, class of subscribers, individual request or class of request for content, etc.; or a combination thereof. This may occur, for example, where information retrieval resource conflicts exist between simultaneous requests for information made by different users having different priority-indicative parameters associated therewith, requiring arbitration by the system between the two requests. Further information on differentiated services (e.g., differentiated business services, differentiated information services), and types of priority-indicative parameters and methods and systems which may be employed for implementing the same, may be found, for example, in co-pending U.S. patent application Ser. No. 09/879,810 filed on Jun. 12, 2001 and entitled SYSTEMS AND METHODS FOR PROVIDING DIFFERENTIATED SERVICE IN INFORMATION MANAGEMENT ENVIRONMENTS, which has been incorporated herein by reference.

As described in the above-captioned reference, the term “differentiated service” includes differentiated information management/manipulation services, functions or tasks (i.e., “differentiated information service”) that may be implemented at the system and/or processing level, as well as “differentiated business service” that may be implemented, for example, to differentiate information exchange between different network entities such as different network provider entities, different network user entities, etc.

The disclosed systems and methods may be implemented in a deterministic manner to provide “differentiated information service” in a network environment, for example, to allow one or more information retrieval tasks associated with particular requests for information retrieval to be performed differentially relative to other information retrieval tasks. As used herein, “deterministic information management” includes the manipulation of information (e.g., information retrieval from storage, delivery, routing or re-routing, serving, storage, caching, processing, etc.) in a manner that is based at least partially on the condition or value of one or more system or subsystem parameters. Examples of such parameters include, but are not limited to, system or subsystem resources such as available storage access, available application memory, available processor capacity, available network bandwidth, etc. Such parameters may be utilized in a number of ways to deterministically manage information.

In one embodiment the disclosed systems and methods may be implemented to make possible session-aware differentiated service. Session-aware differentiated service may be characterized as the differentiation of information management/manipulation services, functions or tasks at a level that is higher than the individual packet level, and that is higher than the individual packet vs. individual packet level. For example, the disclosed systems and methods may be implemented to differentiate information based on status of one or more parameters associated with an information manipulation task itself, such as information retrieval from a storage device to buffer/cache memory itself, status of one or more parameters associated with a request for such an information manipulation task, status of one or more parameters associated with a user requesting such an information manipulation task, status of one or more parameters associated with service provisioning information, status of one or more parameters associated with system performance information, combinations thereof, etc. Specific examples of such parameters include class identification parameters (e.g., policy-indicative parameters associated with information management policy), service class parameters (e.g., parameter based on content, parameter based on application, parameter based on user system performance parameters, etc.) system performance parameters (e.g., resource availability and/or usage, adherence to provisioned SLA policies, content usage patterns, time of day access patterns, etc.), and system service parameters (e.g., aggregate bandwidth ceiling; internal and/or external service level agreement policies such as policies for treatment of particular information requests based on individual request and/or individual subscriber, class of request and/or class of subscriber, including or based on QoS, CoS and/or other class/service identification parameters associated therewith; admission control policy; information metering policy; classes per tenant; system resource allocation such as bandwidth, processing and/or storage resource allocation per tenant and/or class for a number of tenants and/or number of classes; etc.

In one embodiment, session-aware differentiated service may include differentiated service that may be characterized as resource-aware (e.g., content delivery resource-aware, etc.) and, in addition to resource monitoring, the disclosed systems and methods may be additionally or alternatively implemented to be capable of dynamic resource allocation (e.g., dynamic information retrieval resource allocation per application, per tenant, per class, per subscriber, etc.).

The term “differentiated information service” includes any information management service, function or separate information manipulation task/s that is performed in a differential manner, or performed in a manner that is differentiated relative to other information management services, functions or information manipulation tasks, for example, based on one or more parameters associated with the individual service/function/task or with a request generating such service/function/task. Included within the definition of “differentiated information service” are, for example, provisioning, monitoring, management and reporting functions and tasks. Specific examples include, but are not limited to, prioritization of data traffic flows, provisioning of resources (e.g., disk IOPS and CPU processing resources), etc. As it relates to the disclosed systems and methods for intelligent information retrieval, specific examples of differentiated service also include prioritization of information retrieval, for example, prioritizing the determined information retrieval rate of at least one given request for information relative to other simultaneous requests for information (e.g., allocating available information retrieval resources among the requests by manipulating the determination of information retrieval rate for fulfillment of the individual requests) based on the relative priority status of at least one parameter associated with the given request that is indicative of a relative priority of the given request in relation to the priority of the other requests. This may be implemented in times of system congestion or overcapacity, for example, so that determined information retrieval rates associated with requests having higher relative priority are employed that are sufficient to ensure delivery of information to service higher relative priority requests without hiccups or other interruptions, at the expense of employing determined information retrieval rates associated with requests having lower relative priority that may be reduced or insufficient to ensure delivery of information to service lower relative priority requests without hiccups or other interruptions.

A “differentiated business service” includes any information management service or package of information management services that may be provided by one network entity to another network entity (e.g., as may be provided by a host service provider to a tenant and/or to an individual subscriber/user), and that is provided in a differential manner or manner that is differentiated between at least two network entities. In this regard, a network entity includes any network presence that is or that is capable of transmitting, receiving or exchanging information or data over a network (e.g., communicating, conducting transactions, requesting services, delivering services, providing information, etc.) that is represented or appears to the network as a networking entity including, but not limited to, separate business entities, different business entities, separate or different network business accounts held by a single business entity, separate or different network business accounts held by two or more business entities, separate or different network ID's or addresses individually held by one or more network users/providers, combinations thereof, etc. A business entity includes any entity or group of entities that is or that is capable of delivering or receiving information management services over a network including, but not limited to, host service providers, managed service providers, network service providers, tenants, subscribers, users, customers, etc.

A differentiated business service may be implemented to vertically differentiate between network entities (e.g., to differentiate between two or more tenants or subscribers of the same host service provider/ISP, such as between a subscriber to a high cost/high quality content delivery plan and a subscriber to a low cost/relatively lower quality content delivery plan), or may be implemented to horizontally differentiate between network entities (e.g., as between two or more host service providers/ISPs, such as between a high cost/high quality service provider and a low cost/relatively lower quality service provider). Included within the definition of “differentiated business service” are, for example, differentiated classes of service that may be offered to multiple subscribers. For example, the disclosed methods and systems may be implemented to deterministically differentiate between at least two network entities in a session-aware manner based at least in part on one or more respective parameters associated with each of the at least two network entities, one or more respective parameters associated with particular requests for information management received from each of the at least two entities, or a combination thereof. The network entities may each comprise, for example, respective individual business entities, and differentiation may be made therebetween in a session-aware manner. Specific examples of such individual business entities include, but are not limited to, co-tenants of an information management system, co-subscribers of information management services provided by an information management system, combinations thereof, etc. In one exemplary embodiment, such individual business entities may be co-subscribers of information management services provided by an information management system that uses the disclosed methods and systems to provide differentiated classes of service to the co-subscribers. In another exemplary embodiment, differentiated quality of service may be provided to said co-subscribers on a per-class of service basis, per-subscriber basis, combination thereof, etc.

Using the disclosed methods and systems, differentiated service (differentiated information service and/or differentiated business service) may be implemented in the determination of information retrieval rates by, for example, varying the information retrieval relationship between monitored information delivery rate and the corresponding determined information retrieval rate, based at least partially on the based on the status of one or more parameters associated with an information retrieval task itself, status of one or more parameters associated with a request for such an information retrieval task, status of one or more parameters associated with a user requesting such an information retrieval task, status of one or more parameters associated with service provisioning information, status of one or more parameters associated with system performance information, combinations thereof, etc. For example, where information retrieval resources are limited, only a portion of information retrieval requests may be serviced at information retrieval rates determined to ensure no hiccups or interruptions in information delivery (e.g. information retrieval rate equal to or greater than corresponding monitored information delivery rate), while the remainder of information retrieval rates are serviced at determined information retrieval rates that are less than sufficient to ensure no hiccups or interruptions in information delivery (e.g. information retrieval rate less than corresponding monitored information delivery rate). Thus, it is possible to ensure that higher priority information retrieval requests are assured interruption-free delivery of information, while lower priority information retrieval requests may experience degraded performance during times of congestion.

With regard to information retrieval relationships, it will be understood that where desired, determination of information retrieval rates may be varied (e.g., among any number of different information retrieval requests, any number of classes of such requests or users making such requests, etc.) using any suitable methodology. For example, determined information retrieval rates may be varied (i.e., reduced or increased) in relation to other information retrieval requests by pre-determined scaling factors, by scaling factors calculated based on real-time monitored information retrieval resources (e.g., storage system retrieval resources), by scaling factors calculated based on number and associated priorities of given information retrieval requests, any of the other parameters associated with differentiated services described herein, combinations thereof, etc. Alternatively, different algorithms or other relationships for determining information retrieval rates based at least in part on monitored information delivery rates may be implemented or substituted for each other to achieve the desired differentiated allocation of differing determined information retrieval rates among two or more different information retrieval requests or users making such requests . In this regard, as few as two different relationships up to a large number of such different relationships may be employed respectively to differentiate the determination of information retrieval rates for two or more different respective users, e.g. of the same information delivery system. Such relationships may be implemented as selectable predetermined relationships (e.g., selectable for each user based on a priority-indicative parameter associated with the user and/or a request received from the user). Alternatively, such relationships may be formulated or derived in real-time based on monitored system parameters including, but not limited to, number of simultaneous requests for information, particular combination of priority-indicative parameters associated with such requests and/or users making such requests, information retrieval resource utilization, information retrieval resource availability, combinations thereof, etc.

In one exemplary embodiment, information retrieval bandwidth allocation, e.g., maximum and/or minimum information retrieval bandwidth per CoS, may be defined and provisioned. In this regard, maximum bandwidth per CoS may be described as an aggregate policy defined per CoS for class behavior control in the event of overall system information retrieval bandwidth congestion. Such a parameter may be employed to provide an information retrieval rate control mechanism for allocating available information retrieval resources, and may be used in the implementation of a policy that enables CBR-type classes to always remain protected, regardless of over-subscription by VBR-type and/or best effort-type classes. For example, a maximum information retrieval bandwidth ceiling per CoS may be defined and provisioned. In such an embodiment, VBR-type classes may also be protected if desired, permitting them to dip into information retrieval rate bandwidth allocated for best effort-type classes, either freely or to a defined limit.

Minimum information retrieval rate bandwidth per CoS may be described as an aggregate policy per CoS for class behavior control in the event of overall system bandwidth congestion. Such a parameter may also be employed to provide a control mechanism for information retrieval rates, and may be used in the implementation of a policy that enables CBR-type and/or VBR-type classes to borrow information retrieval bandwidth from a best effort-type class down to a floor or minimum bandwidth value. It will be understood that the above-described embodiments of maximum and minimum bandwidth per CoS are exemplary only, and that values, definition and/or implementation of such parameters may vary, for example, according to needs of an individual system or application, as well as according to identity of actual per flow egress bandwidth CoS parameters employed in a given system configuration. For example an adjustable bandwidth capacity policy may be implemented allowing VBR-type classes to dip into information retrieval rate bandwidth allocated for best effort-type classes either freely or to a defined limit.

As previously mentioned, a single QoS or combination of QoS policies may be defined and provisioned on a per CoS, or on a per subscriber basis. For example, when a single QoS policy is provisioned per CoS, end subscribers who “pay” for, or who are otherwise assigned to a particular CoS are treated equally within that class when the system is in a congested state, and are only differentiated within the class by their particular sustained/peak subscription. When multiple QoS policies are provisioned per CoS, end subscribers who “pay” for, or who are otherwise assigned to a certain class are differentiated according to their particular sustained/peak subscription and according to their assigned QoS. When a unique QoS policy is defined and provisioned per subscriber, additional service differentiation flexibility may be achieved. In one exemplary embodiment, QoS policies may be applicable for CBR-type and/or VBR-type classes whether provisioned and defined on a per CoS or on a per QoS basis. It will be understood that the embodiments described herein are exemplary only and that CoS and/or QoS policies as described herein may be defined and provisioned in both single tenant per system and multi-tenant per system environments.

While the invention may be adaptable to various modifications and alternative forms, specific embodiments have been shown by way of example and described herein. However, it should be understood that the invention is not intended to be limited to the particular forms disclosed. Rather, the invention is to cover all modifications, equivalents, and alternatives falling within the spirit and scope of the invention as defined by the appended claims. Moreover, the different aspects of the disclosed systems and methods may be utilized in various combinations and/or independently. Thus the invention is not limited to only those combinations shown herein, but rather may include other combinations.

What is claimed is:

1. A method of retrieving information for delivery across a network to at least one user, comprising:
monitoring an information delivery rate across said network to said user;
determining an information retrieval rate based at least in part on said monitored information delivery rate;
retrieving information from at least one storage device coupled to said network at said determined information retrieval rate; and
delivering said retrieved information across said network to said user.

2. The method of claim 1, wherein said method further comprises adjusting said determined information retrieval rate on a real time basis by monitoring said information delivery rate across said network to said user on a real time basis; and determining said information retrieval rate on a real time basis based at least in part on said real time monitored information delivery rate.

3. The method of claim 1, wherein said information comprises memory units of a data object that comprises multiple memory units; and wherein said method further comprises storing said memory units in a buffer/cache memory prior to delivering said retrieved memory units across said network to said user.

4. The method of claim 3, wherein said information comprises memory units of a first data object comprising multiple memory units for delivery to a first user; and wherein said method further comprises retrieving and storing memory units in said buffer/cache memory for at least one additional data object comprising multiple memory units for delivery to at least one additional user; and wherein said memory units of said first data object and said memory units of said second data object are simultaneously stored in said buffer/cache memory.

5. The method of claim 4, wherein the total of the number of memory units associated with said first data object and the number of memory units associated with said at least one additional data object equals or exceeds the available memory size of said buffer/cache memory.

6. The method of claim 3, wherein said storage device comprises a disk storage device; wherein said information comprises memory units of a first data object comprising multiple disk blocks for delivery to a first user; and wherein said method further comprises retrieving and storing memory units in said buffer/cache memory for at least one additional data object comprising multiple disk blocks for delivery to at least one additional user; wherein said memory units of said first data object and said memory units of said second data object are simultaneously stored in said buffer/cache memory; and wherein the total of the number of memory units associated with said first data object and the number of memory units associated with said at least one additional data object equals or exceeds the available memory size of said buffer/cache memory.

7. The method of claim 1, wherein said information comprises memory units of an over-size data object; wherein said delivering comprises delivering said memory units to said user in response to a request for information from said user; and wherein said method further comprises storing said memory units in a buffer/cache memory prior to delivering said retrieved memory units across said network to said user.

8. The method of claim 3, wherein said determined information retrieval rate is equal to said monitored information delivery rate.

9. The method of claim 3, wherein said determined information retrieval rate is proportional to said monitored information delivery rate.

10. The method of claim 3, wherein said determined information retrieval rate is sufficient to ensure that memory units of said data object are stored and resident within said buffer/cache memory when said memory units are required to be delivered to said user in a manner that prevents interruption or hiccups in the delivery of said data object.

11. The method of claim 3, wherein said method comprises:
monitoring a first information delivery rate across said network for a first user, and monitoring a second information delivery rate across said network for a second user;
determining a first information retrieval rate for said first user based at least in part on said first monitored information delivery rate, and determining a second information retrieval rate for said second user based at least in part on said second monitored information delivery rate;
retrieving first memory units at said first determined information retrieval rate from said at least one storage device, and storing said first memory units in said buffer/cache memory;
retrieving second memory units at said second determined information retrieval rate from said at least one storage device, and storing said second memory units in said buffer/cache memory;
delivering said first retrieved memory units from said buffer/cache memory to said first user; and
delivering said second retrieved memory units from said buffer/cache memory to said second user.

12. The method of claim 11, wherein said first determined information retrieval rate is determined based at least in part on said first monitored information delivery rate using a first information retrieval relationship; wherein said second determined information retrieval rate is determined based at least in part on said second monitored information delivery rate using a second information retrieval relationship; and wherein said first information retrieval relationship differs from said second information retrieval relationship.

13. The method of claim 11, wherein said first information retrieval relationship differs from said second information retrieval relationship based at least in part on one or more priority-indicative parameters associated with at least one of a request for said information received from said first or second users; one or more priority-indicative parameters associated with at least one user requesting said delivery of said information, or a combination thereof.

14. The method of claim 11, wherein said first information retrieval relationship differs from said second information retrieval relationship based at least in part on one or more class identification parameters, one or more system performance parameters, or a combination thereof.

15. The method of claim 3, wherein said memory units are retrieved from at least one storage device by a storage management processing engine coupled to said at least one storage device; wherein said memory units are stored in a buffer/cache memory of said storage management processing engine; wherein a request for said memory units is received from a server coupled between said storage management processing engine and said network; and wherein said memory units are delivered from said buffer/cache memory to said user via said server.

16. The method of claim 3, wherein said memory units are retrieved from at least one storage device by a server processor coupled to said at least one storage device; wherein said memory units are stored in a buffer/cache memory of said server; and wherein said memory units are delivered from said buffer/cache memory of said server to said user.

17. The method of claim 3, wherein said memory units are retrieved from at least one storage device by a storage management processing engine of an information management system coupled to said network; wherein said memory units are stored in a buffer/cache memory of said information management system; wherein a request for said memory units is received from at least one other processing engine of said information management system coupled to said storage management processing engine; and wherein said memory units are delivered to said user from said information management system across said network.

18. The method of claim 1, wherein said information comprises memory units of two or more data objects contiguously stored on said at least one storage device and related to one another by at least one inter-data object relationship; and wherein said retrieving comprises retrieving said two or more data objects together from said at least one storage device.

19. The method of claim 1, wherein said information comprises a non-contiguously placed data object stored on said at least one storage device; and wherein said retrieving comprises retrieving said non-contiguously placed data object using a read ahead size that is equal to or less than a storage device block size of said non-contiguously placed data object on said at least one storage device.

20. The method of claim 17, wherein said memory units are delivered from said buffer/cache memory to said network in a manner that bypasses said at least one other processing engine of said information management system.

21. The method of claim 17, wherein said information management system comprises a content delivery system; and wherein said data object comprises continuous streaming media data.

22. The method of claim 21, wherein said information management system comprises an endpoint content delivery system.

23. A method of retrieving information from a storage system having at least one storage management processing engine coupled to at least one storage device and delivering said information across a network to a user from a server coupled to said storage system, said method comprising:
monitoring an information delivery rate across said network from said server to said user;
determining an information retrieval rate based at least in part on said monitored information delivery rate;
using said storage management processing engine to retrieve information from said at least one storage device at said determined information retrieval rate and to store said retrieved information in a buffer/cache memory of said storage management processing engine; and
delivering said stored information from said buffer/cache memory across said network to said user via said server.

24. The method of claim 23, wherein said information comprises memory units of a data object that comprises multiple memory units; and wherein said delivering comprises delivering said memory units to said user via said server in response to a request for said information received by said storage management processing engine from said server.

25. The method of claim 24, wherein said method further comprises adjusting said determined information retrieval rate on a real time basis by monitoring said information delivery rate across said network from said server to said user on a real time basis; and determining said information retrieval rate on a real time basis based at least in part on said real time monitored information delivery rate.

26. The method of claim 24, further comprising identifying a request from said user for information that comprises a request for a data object having a size less than a block or stripe size of said storage device; and in response to said identification not storing memory units of said data object having a size less than a block or stripe size of said storage device in said buffer/cache memory.

27. The method of claim 24, wherein said information delivery rate is monitored by at least one processor of said server; wherein said method further comprises communicating said monitored information delivery rate to said storage management processing engine; and wherein said information retrieval rate is determined by said storage management processing engine based at least in part on said monitored information delivery rate.

28. The method of claim 27, wherein said determined information retrieval rate is equal to said monitored information delivery rate.

29. The method of claim 27, wherein said determined information retrieval rate is proportional to said monitored information delivery rate.

30. The method of claim 27, wherein said determined information retrieval rate is sufficient to ensure that requested memory units of said data object are stored and resident within said buffer/cache memory when said request is received.

31. The method of claim 27, wherein said method comprises:
monitoring a first information delivery rate across said network for a first user, and monitoring a second information delivery rate across said network for a second user;
determining a first information retrieval rate for said first user based at least in part on said first monitored information delivery rate, and determining a second information retrieval rate for said second user based at least in part on said second monitored information delivery rate;
retrieving first memory units at said first determined information retrieval rate from said at least one storage device, and storing said first memory units in said buffer/cache memory;
retrieving second memory units at said second determined information retrieval rate from said at least one storage device, and storing said second memory units in said buffer/cache memory;
delivering said first retrieved memory units from said buffer/cache memory to said first user; and
delivering said second retrieved memory units from said buffer/cache memory to said second user.

32. The method of claim 31, wherein said first determined information retrieval rate is determined based at least in part on said first monitored information delivery rate using a first information retrieval relationship; wherein said second determined information retrieval rate is determined based at least in part on said second monitored information delivery rate using a second information retrieval relationship; and wherein said first information retrieval relationship differs from said second information retrieval relationship.

33. The method of claim 31, wherein said first information retrieval relationship differs from said second information retrieval relationship based at least in part on one or more priority-indicative parameters associated with at least one of a request for said information received from said first or second users; one or more priority-indicative parameters associated with at least one user requesting said delivery of said information, or a combination thereof.

34. The method of claim 31, wherein said first information retrieval relationship differs from said second information retrieval relationship based at least in part on one or more class identification parameters, one or more system performance parameters, or a combination thereof.

35. The method of claim 24, wherein said storage system comprises an endpoint storage system; and wherein said data object comprises continuous streaming media data.

36. The method of claim 24, wherein said at least one storage device comprises a RAID storage disk array; and wherein said storage management processing engine comprises a RAID controller.

37. A network-connectable storage system, comprising:
at least one storage device; and
a storage management processing engine coupled to said at least one storage device, said storage management processing engine including a buffer/cache memory;
wherein said storage management processing engine is capable of determining an information retrieval rate for retrieving information from said storage device and storing said information in said buffer/cache memory, said information retrieval rate being determined based at least in part on a monitored information delivery rate from a server to a user across said network that is communicated to said storage management processing engine from a server coupled to said storage management processing engine.

38. The system of claim 37, further comprising a server coupled between a network and said storage management processing engine; wherein said information delivery rate comprises a delivery rate for information delivered to a user from said server across said network; and wherein said server includes a processor capable of monitoring said information delivery rate; and wherein said server is further capable of communicating said monitored information delivery rate to said storage management processing engine; wherein said information comprises memory units of a data object that comprises multiple memory units; and wherein said storage management processing engine is capable of delivering said memory units to said user via said server in response to a request for said memory units received by said storage management processing engine from said server.

39. The method of claim 38, wherein said storage management processing engine is further capable of adjusting said determined information retrieval rate on a real time basis by monitoring said information delivery rate across said network from said server to said user on a real time basis; and determining said information retrieval rate on a real time basis based at least in part on said real time monitored information delivery rate.

40. The system of claim 38, wherein said server processor is further capable of identifying a request for information that comprises a request from said user for a data object having a size less than a block or stripe size of said storage device; and in response to said identification of said data object having a size less than a block or stripe size of said storage device performing at least one of: not communicating said monitored information delivery rate to said storage processing engine, communicating to said storage management processing engine an indicator or tag that storage in said buffer/cache memory is not required for memory units of said requested data object, or a combination thereof.

41. The system of claim 38, wherein said determined information retrieval rate is equal to said monitored information delivery rate.

42. The system of claim 38, wherein said determined information retrieval rate is proportional to said monitored information delivery rate.

43. The system of claim 38, wherein said determined information retrieval rate is sufficient to ensure that requested memory units of said data object are stored and resident within said buffer/cache memory when said request is received.

44. The system of claim 38, wherein said server comprises at least one processor capable of monitoring a first information delivery rate across said network for a first user, and monitoring a second information delivery rate across said network for a second user; wherein said storage management processing engine is capable of determining a first information retrieval rate for said first user based at least in part on said first monitored information delivery rate, and determining a second information retrieval rate for said second user based at least in part on said second monitored information delivery rate; wherein said storage management engine is further capable of retrieving first memory units at said first determined information retrieval rate from said at least one storage device, and storing said first memory units in said buffer/cache memory, and retrieving second memory units at said second determined information retrieval rate from said at least one storage device, and storing said second memory units in said buffer/cache memory; and wherein said storage management processing engine is further capable of delivering said first retrieved memory units from said buffer/cache memory to said server for delivery across said network to said first user, and delivering said second retrieved memory units from said buffer/cache memory to said server for delivery across said network to said second user.

45. The system of claim 44, wherein said first determined information retrieval rate is based at least in part on said first monitored information delivery rate using a first information retrieval relationship; wherein said second determined information retrieval rate is based at least in part on said second monitored information delivery rate using a second information retrieval relationship; and wherein said first information retrieval relationship differs from said second information retrieval relationship.

46. The system of claim 44, wherein said first information retrieval relationship differs from said second information retrieval relationship based at least in part on one or more priority-indicative parameters associated with at least one of a request for said information received from said first or second users; one or more priority-indicative parameters associated with at least one user requesting said delivery of said information, or a combination thereof.

47. The system of claim 44, wherein said first information retrieval relationship differs from said second information retrieval relationship based at least in part on one or more class identification parameters, one or more system performance parameters, or a combination thereof.

48. The system of claim 38, wherein said storage system comprises an endpoint storage system; and wherein said data object comprises continuous streaming media data.

49. The system of claim 38, wherein said at least one storage device comprises a RAID storage disk array; and wherein said storage management processing engine comprises a RAID controller.

50. A method of retrieving information from at least one storage device and delivering said information across a network to a user from a server coupled to said storage device, said method comprising:
monitoring an information delivery rate across said network from said server to said user;
determining an information retrieval rate based at least in part on said monitored information delivery rate;
retrieving said information from said at least one storage device at said determined information retrieval rate and storing said retrieved information in a buffer/cache memory coupled to said server; and
delivering said stored information from said buffer/cache memory across said network to said user via said server.

51. The method of claim 50, wherein said information comprises memory units of a data object that comprises multiple memory units; wherein said information delivery rate is monitored by at least one processor of said server; and wherein said information retrieval rate is determined by at least one processor of said server based at least in part on said monitored information delivery rate.

52. The method of claim 51, wherein said method further comprises adjusting said determined information retrieval rate on a real time basis by monitoring said information delivery rate across said network from said server to said user on a real time basis; and determining said information retrieval rate on a real time basis based at least in part on said real time monitored information delivery rate.

53. The method of claim 51, further comprising identifying a request from said user for information that comprises a request for a data object having a size less than a block or stripe size of said storage device; and in response to said identification not storing memory units of said data object having a size less than a block or stripe size of said storage device in said buffer/cache memory.

54. The method of claim 51, wherein said determined information retrieval rate is equal to said monitored information delivery rate.

55. The method of claim 51, wherein said determined information retrieval rate is proportional to said monitored information delivery rate.

56. The method of claim 51, wherein said determined information retrieval rate is sufficient to ensure that memory units of said data object are stored and resident within said buffer/cache memory when said memory units are required to be delivered to said user in a manner that prevents interruption or hiccups in the delivery of said data object.

57. The method of claim 51, wherein said method comprises:
monitoring a first information delivery rate across said network for a first user, and monitoring a second information delivery rate across said network for a second user;
determining a first information retrieval rate for said first user based at least in part on said first monitored information delivery rate, and determining a second information retrieval rate for said second user based at least in part on said second monitored information delivery rate;
retrieving first memory units at said first determined information retrieval rate from said at least one storage device, and storing said first memory units in said buffer/cache memory;
retrieving second memory units at said second determined information retrieval rate from said at least one storage device, and storing said second memory units in said buffer/cache memory;
delivering said first retrieved memory units from said buffer/cache memory to said first user; and
delivering said second retrieved memory units from said buffer/cache memory to said second user.

58. The method of claim 57, wherein said first determined information retrieval rate is determined based at least in part on said first monitored information delivery rate using a first information retrieval relationship; wherein said second determined information retrieval rate is determined based at least in part on said second monitored information delivery rate using a second information retrieval relationship; and wherein said first information retrieval relationship differs from said second information retrieval relationship.

59. The method of claim 57, wherein said first information retrieval relationship differs from said second information retrieval relationship based at least in part on one or more priority-indicative parameters associated with at least one of a request for said information received from said first or second users; one or more priority-indicative parameters associated with at least one user requesting said delivery of said information, or a combination thereof.

60. The method of claim 57, wherein said first information retrieval relationship differs from said second information retrieval relationship based at least in part on one or more class identification parameters, one or more system performance parameters, or a combination thereof.

61. The method of claim 51, wherein said data object comprises continuous streaming media data.

62. The method of claim 51, wherein said at least one storage device comprises a RAID storage disk array; and wherein said storage management processing engine comprises a RAID controller.

63. A network-connectable server system, said system comprising:
a server including at least one server processor; and
a buffer cache memory coupled to said server;
wherein said server is further connectable to at least one storage device; and
wherein said at least one server processor is capable of monitoring an information delivery rate across a network from said server to a user, and is further capable of determining an information retrieval rate for retrieving information from said storage device and storing said information in said buffer/cache memory, said information retrieval rate being determined based at least in part on said monitored information delivery rate.

64. The system of claim 63, wherein said information comprises memory units of a data object that comprises multiple memory units.

65. The system of claim 64, wherein said at least one server processor is capable of adjusting said determined information retrieval rate on a real time basis by monitoring said information delivery rate across said network from said server to said user on a real time basis; and determining said information retrieval rate on a real time basis based at least in part on said real time monitored information delivery rate.

66. The system of claim 64, wherein said at least one server processor is further capable identifying a request for information that comprises a request from said user for a data object having a size less than a block or stripe size of said storage device; and in response to said identification of said data object having a size less than a block or stripe size of said storage device not storing memory units of said requested data object in said buffer/memory cache.

67. The system of claim 64, wherein said determined information retrieval rate is equal to said monitored information delivery rate.

68. The system of claim 64, wherein said determined information retrieval rate is proportional to said monitored information delivery rate.

69. The system of claim 64, wherein said determined information retrieval rate is sufficient to ensure that memory units of said data object are stored and resident within said buffer/cache memory when said memory units are required to be delivered to said user in a manner that prevents interruption or hiccups in the delivery of said data object.

70. The system of claim 64, wherein said server comprises at least one processor capable of monitoring a first information delivery rate across said network for a first user, and monitoring a second information delivery rate across said network for a second user; wherein at least one server processor is capable of determining a first information retrieval rate for said first user based at least in part on said first monitored information delivery rate, and determining a second information retrieval rate for said second user based at least in part on said second monitored information delivery rate; wherein said server is capable of retrieving first memory units at said first determined information retrieval rate from said at least one storage device, and storing said first memory units in said buffer/cache memory, and retrieving second memory units at said second determined information retrieval rate from said at least one storage device, and storing said second memory units in said buffer/cache memory; and wherein said server is further capable of delivering said first retrieved memory units from said buffer/cache memory across said network to said first user, and delivering said second retrieved memory units from said buffer/cache memory across said network to said second user.

71. The system of claim 70, wherein said first determined information retrieval rate is based at least in part on said first monitored information delivery rate using a first information retrieval relationship; wherein said second determined information retrieval rate is based at least in part on said second monitored information delivery rate using a second information retrieval relationship; and wherein said first information retrieval relationship differs from said second information retrieval relationship.

72. The system of claim 70, wherein said first information retrieval relationship differs from said second information retrieval relationship based at least in part on one or more priority-indicative parameters associated with at least one of a request for said information received from said first or second users; one or more priority-indicative parameters associated with at least one user requesting said delivery of said information, or a combination thereof.

73. The system of claim 70, wherein said first information retrieval relationship differs from said second information retrieval relationship based at least in part on one or more class identification parameters, one or more system performance parameters, or a combination thereof.

74. The system of claim 64, wherein said data object comprises continuous streaming media data.

75. The system of claim 64, wherein said at least one storage device comprises a RAID storage disk array; and wherein said at least one server processor coupled to said server is capable of acting as a RAID controller.

76. A method of retrieving information from an information management system having at least one first processing engine coupled to at least one storage device and delivering said information across a network to a user from a second processing engine of said information management system coupled to said first processing engine, said method comprising:
monitoring an information delivery rate across said network from said second processing engine to said user;
determining an information retrieval rate based at least in part on said monitored information delivery rate;
using said second processing engine to retrieve information from said at least one storage device at said determined information retrieval rate and to store said retrieved information in a buffer/cache memory of said information management system; and
delivering said stored information from said buffer/cache memory across said network to said user via said second processing engine;
wherein said first processing engine comprises a storage management processing engine; and wherein said first and second processing engines are processing engines communicating as peers in a peer to peer environment via a distributed interconnect coupled to said processing engines.

77. The method of claim 76, wherein said information comprises memory units of a data object that comprises multiple memory units; and wherein said delivering comprises delivering said memory units to said user via said second processing engine in response to a request for said information received by said storage management processing engine from said second processing engine.

78. The method of claim 77, wherein said method further comprises adjusting said determined information retrieval rate on a real time basis by monitoring said information delivery rate across said network from said second processing engine to said user on a real time basis; and determining said information retrieval rate on a real time basis based at least in part on said real time monitored information delivery rate.

79. The method of claim 77, further comprising identifying a request from said user for information that comprises a request for a data object having a size less than a block or stripe size of said storage device; and in response to said identification not storing memory units of said data object having a size less than a block or stripe size of said storage device in said buffer/cache memory.

80. The method of claim 77, wherein said information delivery rate is monitored by said second processing engine; wherein said method further comprises communicating said monitored information delivery rate to said storage management processing engine; and wherein said information retrieval rate is determined by said storage management processing engine based at least in part on said monitored information delivery rate.

81. The method of claim 80, wherein said determined information retrieval rate is equal to said monitored information delivery rate.

82. The method of claim 80, wherein said determined information retrieval rate is proportional to said monitored information delivery rate.

83. The method of claim 80, wherein said determined information retrieval rate is sufficient to ensure that requested memory units of said data object are stored and resident within said buffer/cache memory when said request is received.

84. The method of claim 80, wherein said method comprises:
monitoring a first information delivery rate across said network for a first user, and monitoring a second information delivery rate across said network for a second user;
determining a first information retrieval rate for said first user based at least in part on said first monitored information delivery rate, and determining a second information retrieval rate for said second user based at least in part on said second monitored information delivery rate;
retrieving first memory units at said first determined information retrieval rate from said at least one storage device, and storing said first memory units in said buffer/cache memory;
retrieving second memory units at said second determined information retrieval rate from said at least one storage device, and storing said second memory units in said buffer/cache memory;
delivering said first retrieved memory units from said buffer/cache memory to said first user; and
delivering said second retrieved memory units from said buffer/cache memory to said second user.

85. The method of claim 84, wherein said first determined information retrieval rate is determined based at least in part on said first monitored information delivery rate using a first information retrieval relationship; wherein said second determined information retrieval rate is determined based at least in part on said second monitored information delivery rate using a second information retrieval relationship; and wherein said first information retrieval relationship differs from said second information retrieval relationship.

86. The method of claim 84, wherein said first information retrieval relationship differs from said second information retrieval relationship based at least in part on one or more priority-indicative parameters associated with at least one of a request for said information received from said first or second users; one or more priority-indicative parameters associated with at least one user requesting said delivery of said information, or a combination thereof.

87. The method of claim 84, wherein said first information retrieval relationship differs from said second information retrieval relationship based at least in part on one or more class identification parameters, one or more system performance parameters, or a combination thereof.

88. The method of claim 77, wherein said information management system comprises an endpoint content delivery system; and wherein said data object comprises continuous streaming media data.

89. A network-connectable information management system, comprising:
at least one storage device;
a first processing engine comprising a storage management processing engine coupled to said at least one storage device;
a buffer/cache memory;
a network interface connection to couple said information management system to a network; and
a second processing engine coupled between said first processing engine and said network interface connection;
wherein said storage management processing engine is capable of determining an information retrieval rate for retrieving information from said storage device and storing said information in said buffer/cache memory, said information retrieval rate being determined based at least in part on a monitored information delivery rate from said second processing engine to a user across said network that is communicated to said storage management processing engine from said second processing engine.

90. The system of claim 89, wherein said information delivery rate comprises a delivery rate for information delivered to a user from said second processing engine across said network; and wherein said second processing engine is capable of monitoring said information delivery rate; and wherein said second processing engine is further capable of communicating said monitored information delivery rate to said storage management processing engine; wherein said information comprises memory units of a data object that comprises multiple memory units; and wherein said storage management processing engine is capable of delivering said memory units to said user via said second processing engine in response to a request for said memory units received by said storage management processing engine from said second processing engine.

91. The system of claim 90, wherein said storage management processing engine is further capable of adjusting said determined information retrieval rate on a real time basis by monitoring said information delivery rate across said network from said second processing engine to said user on a real time basis; and determining said information retrieval rate on a real time basis based at least in part on said real time monitored information delivery rate.

92. The system of claim 90, wherein said second processing engine is further capable of identifying a request for information that comprises a request from said user for a data object having a size less than a block or stripe size of said storage device; and in response to said identification of said data object having a size less than a block or stripe size of said storage device performing at least one of: not communicating said monitored information delivery rate to said storage processing engine, communicating to said storage management processing engine an indicator or tag that storage in said buffer/cache memory is not required for memory units of said requested data object, or a combination thereof.

93. The system of claim 90, wherein said determined information retrieval rate is equal to said monitored information delivery rate.

94. The system of claim 90, wherein said determined information retrieval rate is proportional to said monitored information delivery rate.

95. The system of claim 90, wherein said determined information retrieval rate is sufficient to ensure that requested memory units of said data object are stored and resident within said buffer/cache memory when said request is received.

96. The system of claim 90, wherein said second processing engine is capable of monitoring a first information delivery rate across said network for a first user, and monitoring a second information delivery rate across said network for a second user; wherein said storage management processing engine is capable of determining a first information retrieval rate for said first user based at least in part on said first monitored information delivery rate, and determining a second information retrieval rate for said second user based at least in part on said second monitored information delivery rate; wherein said storage management engine is further capable of retrieving first memory units at said first determined information retrieval rate from said at least one storage device, and storing said first memory units in said buffer/cache memory, and retrieving second memory units at said second determined information retrieval rate from said at least one storage device, and storing said second memory units in said buffer/cache memory; and wherein said storage management processing engine is further capable of delivering said first retrieved memory units from said buffer/cache memory to said second processing engine for delivery across said network to said first user, and delivering said second retrieved memory units from said buffer/cache memory to said second processing engine for delivery across said network to said second user.

97. The system of claim 96, wherein said first determined information retrieval rate is based at least in part on said first monitored information delivery rate using a first information retrieval relationship; wherein said second determined information retrieval rate is based at least in part on said second monitored information delivery rate using a second information retrieval relationship; and wherein said first information retrieval relationship differs from said second information retrieval relationship.

98. The system of claim 96, wherein said first information retrieval relationship differs from said second information retrieval relationship based at least in part on one or more priority-indicative parameters associated with at least one of a request for said information received from said first or second users; one or more priority-indicative parameters associated with at least one user requesting said delivery of said information, or a combination thereof.

99. The system of claim 96, wherein said first information retrieval relationship differs from said second information retrieval relationship based at least in part on one or more class identification parameters, one or more system performance parameters, or a combination thereof.

100. The system of claim 90, wherein said information management system comprises an endpoint content delivery system; and wherein said data object comprises continuous streaming media data.
